(19) United States
(12) Patent Application Publication
(10) Pub. No.: US 2025/0005903 A1
(43) Pub. Date: Jan. 2, 2025

(54) Image Classification Method and Apparatus and Computer Device

(71) Applicant: Tencent Technology (Shenzhen) Company Limited, Shenzhen (CN)

(72) Inventors: Shaohua CHEN, Shenzhen (CN); Tinghao YU, Shenzhen (CN); Haodi HOU, Shenzhen (CN); Yunhao WANG, Shenzhen (CN); Hao LIU, Shenzhen (CN)

(73) Assignee: Tencent Technology (Shenzhen) Company Limited, Shenzhen (CN)

(21) Appl. No.: 18/830,976

(22) Filed: Sep. 11, 2024

Related U.S. Application Data
(63) Continuation of application No. PCT/CN2023/124445, filed on Oct. 13, 2023.

(30) Foreign Application Priority Data
Nov. 9, 2022 (CN) 2022113986935

(51) Int. Cl. G06V 10/764; G06T 5/50; G06T 5/60; G06V 10/77; G06V 10/776; G06V 10/778; G06V 20/70

(52) U.S. Cl. CPC G06V 10/764; G06T 5/50; G06T 5/60; G06V 10/7715; G06V 10/776; G06V 10/778; G06V 20/70; G06T 2207/20081

(57) ABSTRACT

An image classification method is provided, including: mapping a plurality of image patches in a sample image using an image classification model, to obtain a feature map; performing combined processing of at least one layer on the feature map using the image classification model, to obtain a combined-processed feature map by: extracting an intermediate feature of a covered feature patch in a target feature map according to a determined self-attention window, determining an offset window from the self-attention window, and extracting the intermediate feature according to the offset window, to obtain a feature map; determining an image classification feature based on the combined-processed feature map, and performing visually induced feeling-based classification on the sample image according to the image classification feature; and updating a model parameter of the image classification model based on a classification result of the visually induced feeling-based classification, to obtain a target image classification model.

### RELATED APPLICATION

This application is a continuation of and claims the benefit of priority to PCT International Application No. PCT/CN2023/124445, filed on Oct. 13, 2023, which is based on and claims the benefit of priority to Chinese Patent Application No. 2022113986935 filed on Nov. 9, 2022 and entitled “IMAGE CLASSIFICATION MODEL PROCESSING METHOD AND APPARATUS, IMAGE CLASSIFICATION METHOD AND APPARATUS, AND COMPUTER DEVICE”, which are incorporated herein by reference in their entireties.

### FIELD OF THE TECHNOLOGY

This application relates to the field of computer technologies, and in particular, to an image classification method and apparatus, a computer device, a storage medium, and a computer program product.

### BACKGROUND OF THE DISCLOSURE

With the development of computer technologies, an increasing amount of various resource content emerges on the Internet, and the time people spent on browsing the resource content such as pictures, web pages, and videos also gradually increases. Quality of the various resource content on the Internet varies. Some of the content include pictures prone to causing people's antipathy and discomfort, for example, pictures including skin diseases, snakes, bugs, or dense objects, which cause a visual sense of discomfort. Accurate recognition and classification of these discomforting pictures is crucial to improving the quality of the resource content on the Internet.

However, because there are many types of discomforting pictures, it is difficult to effectively classify the images based on people's feelings after viewing the images, resulting in low accuracy of image classification.

### SUMMARY

Various embodiments of this disclosure provide an image classification method, an apparatus, a computer device, a computer-readable storage medium, and a computer program product.

According to an aspect, this disclosure provides an image classification method, performed by a computer device, and including:
obtaining a sample image, and mapping a plurality of image patches in the sample image using an image classification model, to obtain a feature map of the sample image, the feature map including feature patches, and the feature patch being obtained through feature mapping on each of the plurality of image patches;
performing combined processing of at least one layer on the feature map using the image classification model, to obtain a combined-processed feature map outputted through the combined processing of the at least one layer, where in combined processing of each layer: determining a self-attention window, a window size of the self-attention window matching a size of a feature patch in a target feature map inputted at the layer, extracting an intermediate feature of a covered feature patch according to the self-attention window, the covered feature patch being a feature patch covered by the self-attention window in the target feature map, determining an offset window that is offset from the self-attention window, and extracting the intermediate feature according to the offset window, to obtain a feature map outputted at the layer;
determining an image classification feature based on the combined-processed feature map using the image classification model, and performing visually induced feeling-based classification on the sample image according to the image classification feature, to obtain a classification result of the visually induced feeling-based classification; and
updating a model parameter of the image classification model based on the classification result of the visually induced feeling-based classification, to obtain a target image classification model after training.

According to another aspect, this disclosure further provides an image classification apparatus. The apparatus includes:
a sample image obtaining module, configured to: obtain a sample image, and map a plurality of image patches in the sample image using an image classification model, to obtain a feature map of the sample image, the feature map including feature patches, and the feature patch being obtained through feature mapping on each of the plurality of image patches;
a model processing module, configured to perform combined processing of at least one layer on the feature map using the image classification model, to obtain a combined-processed feature map outputted through the combined processing of the at least one layer, where in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract the intermediate feature according to the offset window, to obtain a feature map outputted at the layer;
the model processing module being further configured to: determine an image classification feature based on the combined-processed feature map using the image classification model, and perform visually induced feeling-based classification on the sample image according to the image classification feature, to obtain a classification result of the visually induced feeling-based classification; and
a model updating module, configured to update a model parameter of the image classification model based on the classification result of the visually induced feeling-based classification, to obtain a target image classification model after training.

According to another aspect, this disclosure provides an image classification method, performed by a computer device, and including:
obtaining a to-be-classified image, and mapping a plurality of image patches in the to-be-classified image using an image classification model, to obtain a feature map of the to-be-classified image, the feature map including feature patches, and the feature patch being obtained through feature mapping on each of the plurality of image patches;
performing combined processing of at least one layer on the feature map using the image classification model, to obtain a combined-processed feature map outputted through the combined processing of the at least one layer, where in combined processing of each layer: determining a self-attention window, a window size of the self-attention window matching a size of a feature patch in a target feature map inputted at the layer, extracting an intermediate feature of a covered feature patch according to the self-attention window, the covered feature patch being a feature patch covered by the self-attention window in the target feature map, determining an offset window that is offset from the self-attention window, and extracting the intermediate feature according to the offset window, to obtain a feature map outputted at the layer; and
determining an image classification feature based on the combined-processed feature map using the image classification model, and performing visually induced feeling-based classification on the to-be-classified image according to the image classification feature.

According to another aspect, this disclosure further provides an image classification apparatus. The apparatus includes:
an image obtaining module, configured to: obtain a to-be-classified image, and map a plurality of image patches in the to-be-classified image using an image classification model, to obtain a feature map of the to-be-classified image, the feature map including feature patches, and the feature patch being obtained through feature mapping on each of the plurality of image patches; and
a model processing module, configured to perform combined processing of at least one layer on the feature map using the image classification model, to obtain a combined-processed feature map outputted through the combined processing of the at least one layer, where in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract the intermediate feature according to the offset window, to obtain a feature map outputted at the layer;
the model processing module being configured to: determine an image classification feature based on the combined-processed feature map using the image classification model, and perform visually induced feeling-based classification on the to-be-classified image according to the image classification feature.

According to another aspect, this disclosure further provides a computer device, including a memory and a processor, the memory storing computer-readable instructions, and when executing the computer-readable instructions, the processor executing operations in the method embodiments of this disclosure.

According to another aspect, this disclosure further provides a computer-readable storage medium, having computer-readable instructions stored therein, and when executed by a processor, the computer-readable instructions executing operations in the method embodiments of this disclosure.

According to another aspect, this disclosure further provides a computer program product, including computer-readable instructions, and when executed by a processor, the computer-readable instructions executing operations in the method embodiments of this disclosure.

Details of one or more embodiments of this disclosure are provided in the accompany drawings and descriptions below. Other features, objectives, and advantages of this disclosure will become apparent from the specification, the accompanying drawings, and the claims.

### BRIEF DESCRIPTION OF THE DRAWINGS

To describe the technical solutions in the embodiments of this disclosure or the conventional technology more clearly, the following briefly describes the accompanying drawings required for describing the embodiments or the conventional technology. Apparently, the accompanying drawings in the following descriptions show merely the embodiments of this disclosure, and a person of ordinary skill in the art may still derive other drawings from the disclosed accompanying drawings without creative efforts.

FIG. 1 is an example diagram of an application environment of an image classification method according to an embodiment.

FIG. 2 is an example schematic flowchart of an image classification method according to an embodiment.

FIG. 3 is an example schematic diagram of an image including a discomforting element according to an embodiment.

FIG. 4 is an example schematic diagram of an image including a discomforting element according to another embodiment.

FIG. 5 is an example schematic block diagram of an image classification method according to an embodiment.

FIG. 6 is an example schematic flowchart of determining a training loss by introducing knowledge distillation according to an embodiment.

FIG. 7 is an example schematic flowchart of model updating processing according to an embodiment.

FIG. 8 is an example schematic flowchart of an image classification method according to another embodiment.

FIG. 9 is an example schematic diagram that a whole image with a discomforting reaction in an embodiment.

FIG. 10 is an example schematic block diagram of ViT model processing according to an embodiment.

FIG. 11 is an example schematic flowchart of image enhancement processing according to an embodiment.

FIG. 12 is an example schematic flowchart of determining a training loss by introducing a contrastive loss according to an embodiment.

FIG. 13 is an example structural block diagram of an image classification apparatus according to an embodiment.

FIG. 14 is an example structural block diagram of an image classification apparatus according to another embodiment.

FIG. 15 is an example diagram of an internal structure of a computer device according to an embodiment.

### DESCRIPTION OF EMBODIMENTS

To make the objectives, technical solutions, and advantages of this disclosure clearer, the following further describes this disclosure in detail with reference to the accompanying drawings and the embodiments. The specific embodiments described herein are only used to explain this disclosure, and are not intended to limit this disclosure. The technical solutions in the embodiments of this disclosure are described in the following with reference to the accompanying drawings in the embodiments of this disclosure. Apparently, the described embodiments are merely some rather than all of the embodiments of this disclosure. All other embodiments obtained by a person of ordinary skill in the art based on the embodiments of this disclosure without creative efforts shall fall within the protection scope of this disclosure.

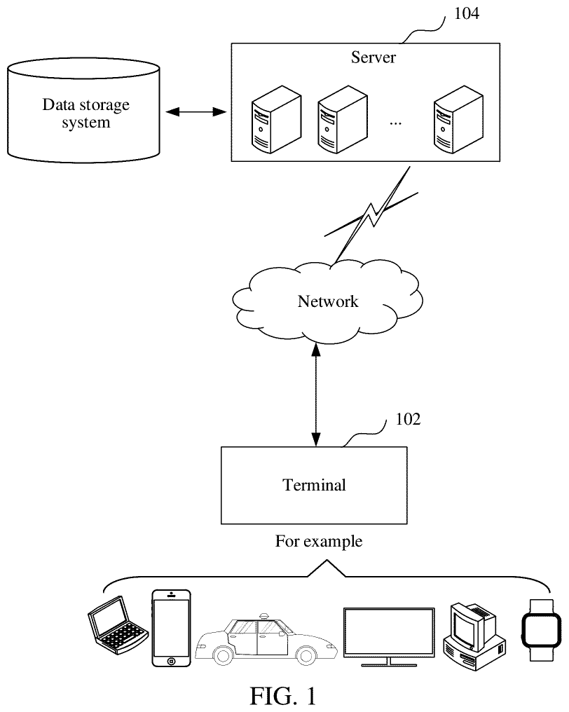

An image classification method provided in an embodiment of this disclosure may be applied to an application environment shown in FIG. 1. A terminal 102 communicates with a server 104 through a network. A data storage system may store data that the server 104 needs to process. The data storage system may be integrated on the server 104, or may be separately disposed, or may be placed on a cloud or another server. The terminal 102 photographs and obtains a sample image, and sends the sample image to the server 104. The server 104 performs combined processing of at least one layer using an image classification model based on a feature map of the sample image, to obtain a combined-processed feature map. In combined processing of each layer, the server 104 performs, according to a self-attention window whose window size matching a size of a feature patch in a target feature map inputted at the layer, self-attention feature extraction on a feature patch covered by the self-attention window in the target feature map; performs, according to an offset window that is offset from the self-attention window, self-attention feature extraction on an obtained intermediate feature to obtain a feature map outputted at the layer; performs visually induced feeling-based classification based on an image classification feature determined based on the combined-processed feature map; and continues to perform training after updating the image classification model based on a classification result of the visually induced feeling-based classification, until training is completed to obtain a trained target image classification model. For the obtained target image classification model, the server 104 may perform visually induced feeling-based classification on an inputted image, and output a visually induced feeling-based classification result, thereby determining whether the inputted image is a visually discomforting image. In addition, the image classification method may alternatively be implemented by the server 104 or the terminal 102 alone.

The image classification method provided in this embodiment of this disclosure may be applied to the application environment shown in FIG. 1. A pre-trained image classification model is disposed in the server 104, and the terminal 102 may send a to-be-classified image on which visually induced feeling-based classification needs to be performed to the server 104. The server 104 performs combined processing of at least one layer using the image classification model based on a feature map of the to-be-classified image, to obtain a combined-processed feature map. In combined processing of each layer, the server 104 performs, according to a self-attention window whose window size matching a size of a feature patch in a target feature map inputted at the layer, self-attention feature extraction on a feature patch covered by the self-attention window in the target feature map; performs, according to an offset window that is offset from the self-attention window, self-attention feature extraction on an obtained intermediate feature, to obtain a feature map outputted at the layer; performs visually induced feeling-based classification based on an image classification feature determined based on the combined-processed feature map; and replies the terminal 102 with an obtained visually induced feeling-based classification result. In addition, the image classification method may alternatively be implemented by the server 104 or the terminal 102 alone.

The terminal 102 may be, but is not limited to, various desktop computers, notebook computers, smartphones, tablet computers, Internet of Things devices, and portable wearable devices. The Internet of Things devices may be smart speakers, smart televisions, smart air conditioners, smart in-vehicle devices, or the like. The portable wearable device may be a smart watch, a smart bracelet, a head-mounted device, or the like. The server 104 may be implemented by using an independent server or a server cluster that includes a plurality of servers.

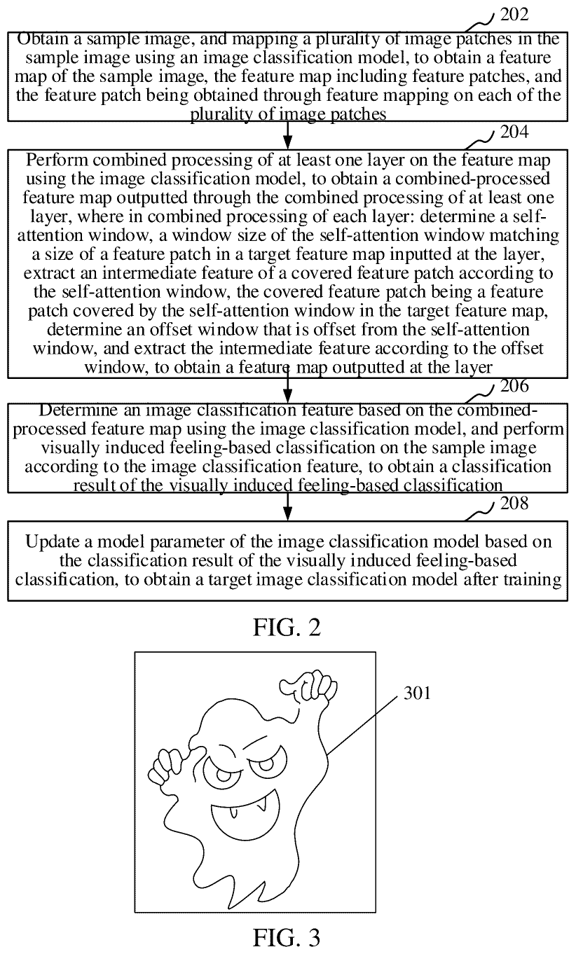

In an embodiment, as shown in FIG. 2, an image classification method is provided. The method is performed by a computer device. Specifically, the method may be separately performed by a computer device such as a terminal or a server, or may be jointly performed by the terminal and the server. In this embodiment of this disclosure, an example in which the method is applied to the server in FIG. 1 is used as an example for description. The method includes the following operations:

Operation 202: Obtain a sample image, and map a plurality of image patches in the sample image using an image classification model, to obtain a feature map of the sample image, the feature map including feature patches, and each of the feature patches being obtained through feature mapping on each of the plurality of image patches.

The sample image is sample data configured for training the image classification model. The sample image may carry a classification label. The sample image may have different classification labels for different classification tasks, and the image classification model may be trained based on the sample image. The image classification model is configured to classify an inputted image. The image classification model may be constructed in different structures according to actual needs, for example, image classification models with different layer structures may be constructed based on a Transformer algorithm, or image classification models with different layer structures may be constructed based on a Convolutional Neural Network (CNN) algorithm. The image patches are obtained by dividing the sample image. A size of the image patch may be set according to actual needs, for example, may be a size of 4 pixels×4 pixels, or a size of 7 pixels×7 pixels. The sample image may be divided into image patches with different granularities in different patch division manners, so that the image classification is performed based on the image patches with different granularities. The feature patches are obtained through feature mapping on the image patches in the sample image. A corresponding feature patch may be obtained through feature mapping on each image patch, and the feature patch represents an image classification characteristic of the image patch. Feature mapping on the image patches may be performed based on different feature extraction manners. For example, the feature patch corresponding to the image patch may be obtained through various feature extraction manners such as linear mapping and embedding mapping. The sample image is divided into a plurality of image patches. A corresponding feature patch may be obtained through feature mapping on each image patch respectively, and the feature map of the sample image may be obtained by combining the feature patches.

Specifically, the server obtains the sample image. The sample image may carry a corresponding classification label. The server maps a plurality of image patches in the sample image using a to-be-trained image classification model to obtain a feature map of the sample image. For example, the server may perform feature mapping on the plurality of image patches in the sample image. Specifically, the sample image may be inputted into the to-be-trained image classification model, so that an image division layer structure in the image classification model perform patch division on the inputted sample image, to obtain a plurality of image patches. Then, a feature mapping layer in the image classification model performs feature mapping on each image patch. For example, a feature extraction layer structure set according to a preset algorithm may perform feature extraction on each image patch, to obtain feature patches respectively corresponding to the plurality of image patches in the sample image. The image classification model obtains the feature map of the sample image based on the feature patches corresponding to the plurality of image patches.

Operation 204: Perform combined processing of at least one layer on the feature map using the image classification model, to obtain a combined-processed feature map outputted through the combined processing of the at least one layer, where in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract the intermediate feature according to the offset window, to obtain a feature map outputted at the layer.

The feature map is used as an input of the combined processing. The combined processing means performing a series of processing on the feature map, and may include a plurality of feature processing operations, for example, include a plurality of processing operations of self-attention feature extraction. A type of output data of the combined processing is also a feature map, in other words, a data type for which the combined processing is specified is a feature map, and a data type outputted by the combined processing is also the feature map. The image classification model performs combined processing of at least one layer on the inputted feature map, and corresponding combined processing is performed on a respective feature map at each layer. The combined processing on the feature map may include at least one layer. Feature processing may be performed on a respective inputted feature map at each layer. The layer corresponds to a structure of the image classification model. Specifically, a plurality of layer structures for feature processing may be set in the image classification model, and each layer structure may correspond to one layer. In this case, combination of the layer structures in the image classification model can implement the combined processing of the at least one layer. When the image classification model includes one layer structure, the image classification model may perform combined processing of one layer on the feature map, that is, the combined processing may be performed only once. When the image classification model includes a plurality of layer structures, the image classification model may perform combined processing of a plurality of layers on the feature map, that is, the combined processing may be performed for a plurality of times in sequence.

In the combined processing of a plurality of layers, combined processing of the first layer may be directly implemented based on the feature map of the sample image, and starting from the combined processing of the second layer, a feature map outputted through combined processing at a previous layer may be used as an input feature map of this layer, so that feature processing can be performed for a plurality of times in the combined processing until combined processing of the last layer is completed, to output the combined-processed feature map. The window size is a size of the self-attention window, in other words, a window size of the self-attention window, and the unit may be pixels. The self-attention window is a window in which self-attention feature extraction processing is performed on the feature map. Self-attention windows of different sizes may cover different quantities of feature patches in the feature map for feature extraction, to obtain self-attention features of different receptive fields. That is, the self-attention window is configured for defining a range of feature patches for each time of self-attention feature extraction. The target feature map is a feature map inputted into the current layer for combined processing. For the combined processing at the first layer, the target feature map is a feature map of the inputted sample image. In combined processing at the second layer and subsequent layers, the target feature map is a feature map outputted through combined processing of the previous layer. The window size of the self-attention window matches a size of the feature patch in the target feature map, and specifically, a correspondence of a specific size multiple may be set. For example, in the window size of the self-attention window, a width of the self-attention window is 4 times a width of the feature patch, and a height of the self-attention window is 4 times a height of the feature patch. In this case, each self-attention window can cover 16 feature patches. In a specific application, for combined processing at each layer, a target feature map inputted at the layer may be determined, and feature patch size analysis is performed on the target feature map, to determine a size of a feature patch in the target feature map, and further to determine a matching self-attention window.

The intermediate feature is a feature map extracted through self-attention feature extraction on a covered feature patch by using the self-attention window, and the covered feature patch is a feature patch covered by the self-attention window in the target feature map. The self-attention feature extraction is feature extraction processing based on a self-attention mechanism. Specifically, association parameters between feature patches may be determined through the self-attention mechanism, to perform feature extraction on the feature map based on the association parameters. There is a specific connection between the feature patches, and a correlation between the feature patches can be established through the self-attention mechanism, so that a feature map with a stronger representation capability can be obtained. In other words, through the self-attention mechanism, the image classification model can learn a correlation between different parts in the inputted feature map. The offset window is obtained by offsetting the self-attention window. Specifically, the offset window may be obtained by offsetting the self-attention window by a specific distance in a specific direction. The self-attention feature extraction is performed on the intermediate feature based on the self-attention mechanism by using the offset window, so that feature expression capability can be further enhanced by establishing information interaction between different self-attention windows.

Specifically, the server performs combined processing of at least one layer on the feature map using the image classification model, to obtain the combined-processed feature map outputted through the combined processing of the at least one layer. For example, at least one combined processing layer in the image classification model may perform combined processing to obtain the combined-processed feature map. In the combined processing of each layer, the image classification model determines a self-attention window whose window size matches a size of a feature patch in the target feature map inputted at the layer, determines a covered feature patch in the target feature map according to the self-attention window, and performs self-attention feature extraction on the covered feature patch, to obtain the intermediate feature. The self-attention window may cover a local area in the target feature map. By constantly moving the self-attention window, self-attention feature extraction on various feature patches in the target feature map can be implemented. The image classification model offsets the self-attention window to obtain the offset window, and performs self-attention feature extraction on the intermediate feature according to the offset window. Specifically, a feature patch covered by the offset window in the intermediate feature may be determined, and self-attention feature extraction may be performed on the feature patch covered by the offset window, to obtain a feature map outputted at the layer, thereby implementing the combined processing of the layer. The feature map outputted through the combined processing of the layer is used as a feature map inputted to combined processing of a next layer, to perform the combined processing of the next layer on the feature map outputted through the combined processing of the layer, to implement combined processing of a plurality of layers, and obtain the combined-processed feature map.

Operation 206: Determine an image classification feature based on the combined-processed feature map using the image classification model, and perform visually induced feeling-based classification on the sample image according to the image classification feature, to obtain a classification result of the visually induced feeling-based classification.

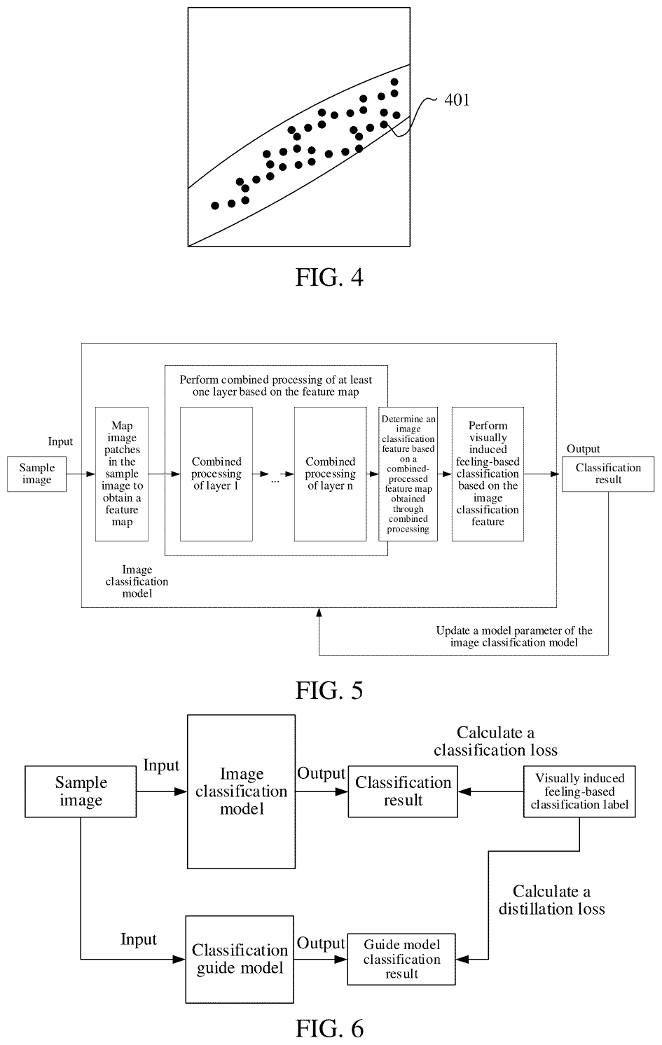

The image classification feature is configured for representing a classification characteristic of the sample image, to perform image classification processing on the sample image. A visually induced feeling (or perception) is a feeling of people when viewing an image, and may be, for example, various feelings such as comfort, pleasure, discomfort, fear, and nausea. In some pictures, if the picture includes discomforting elements such as a snake, a bug, a mouse, a skin disease, and dense objects, when people view this type of picture, a visually induced feeling may be discomfort, which affects people's viewing experience. For example, as shown in FIG. 3, when the picture includes a thrilling element 301, people are prone to uncomfortable experience if they are not prepared. For another example, as shown in FIG. 4, when the picture includes a skin disease, the picture may include rashes 401 on the skin, which also easily causes uncomfortable experience. Therefore, visually induced feeling-based classification is performed on various images to identify discomforting images including discomforting elements, and processing such as masking or adding a mosaic is performed on the discomforting images, which can ensure the viewing experience of users browsing resource content on the Internet. In addition, a recommendation weight of the discomforting image may further be reduced, to avoid recommending such content to specific users, which is beneficial to ensuring physical and mental health of the specific users.

Specifically, the server determines the image classification feature using the image classification model based on the combined-processed feature map. For example, an obtained combined-processed feature may be directly used as the image classification feature, or the image classification feature may be obtained by further performing feature mapping optimization processing on the combined-processed feature. The server performs visually induced feeling-based classification according to the image classification feature, to obtain the classification result of the visually induced feeling-based classification. The classification result may be determined based on a type into which the sample image needs to be classified in the visually induced feeling-based classification. For example, if the visually induced feeling-based classification includes two types: discomforting and non-discomforting, the classification result may be configured for representing whether the sample image belongs to a discomforting image. The visually induced feeling-based classification may alternatively include specific visually induced feeling types, for example, may include four types: happiness, anger, fear, and sadness. In this case, the classification result may be configured for representing an image of which visually induced feeling type the sample image specifically belongs to.

Operation 208: Update a model parameter of the image classification model based on the classification result of the visually induced feeling-based classification, to obtain a target image classification model after training.

Specifically, the server may update the model parameter of the image classification model based on the classification result of the visually induced feeling-based classification. For example, the server may adjust the model parameter of the image classification model based on the classification result of the visually induced feeling-based classification, and continue to perform training based on the image classification model whose parameter is adjusted until training is completed, to obtain the trained target image classification model. The model parameter may include a weight parameter, a mapping parameter, and the like of each layer structure in the image classification model. In a specific implementation, the server may determine a visually induced feeling-based classification label carried by the sample image, determine a difference between the classification result of the visually induced feeling-based classification and the visually induced feeling-based classification label, and update the model parameter of the image classification model according to the difference, to implement training and updating of the image classification model. The target image classification model after training may perform visually induced feeling-based classification on an inputted image, and output a classification result of the visually induced feeling-based classification of the inputted image. The classification result may represent people's visually induced feeling about the inputted image, for example, may be various types of visually induced feelings such as happiness, anger, fear, and sadness.

In a specific application, as shown in FIG. 5, the server may input a sample image into an image classification model, and the image classification model maps image patches in the sample image to obtain a feature map. The image classification model performs combined processing of at least one layer on the feature map of the sample image, where the combined processing of the at least one layer specifically includes combined processing of a layer 1, . . . , combined processing of a layer n, and the like. In the combined processing of each layer, a series of processing may be performed on the target feature map inputted at the corresponding layer. Specifically, the combined processing of each layer may include: according to a self-attention window whose window size matching a size of a feature patch in the target feature map inputted at the layer, performing self-attention feature extraction on a feature patch covered by the self-attention window in the target feature map, and according to an offset window that is offset from the self-attention window, performing self-attention feature extraction on an obtained intermediate feature to obtaining a feature map outputted at the layer. For the combined-processed feature map obtained through the combined processing of the at least one layer, the image classification model determines the image classification feature based on the combined-processed feature map, performs visually induced feeling-based classification based on the image classification feature, and outputs the classification result for the sample image. The server may update the model parameter in the image classification model to obtain the target image classification model after training.

In the foregoing image classification method, combined processing of at least one layer is performed using the image classification model based on a feature map of the sample image, to obtain a combined-processed feature map. In combined processing of each layer, according to a self-attention window whose window size matching a size of a feature patch in a target feature map inputted at the layer, self-attention feature extraction is performed on a feature patch covered by the self-attention window in the target feature map; according to an offset window that is offset from the self-attention window, self-attention feature extraction is performed on an obtained intermediate feature, to obtain a feature map outputted at the layer; visually induced feeling-based classification is performed based on an image classification feature determined based on the combined-processed feature map; the image classification model is updated based on a classification result of the visually induced feeling-based classification, to obtain a target image classification model after training. In training of the target image classification model, in the combined processing of each layer, self-attention feature extraction is sequentially performed through the self-attention window matching the size of the feature patch in the target feature map inputted at the layer and the offset window that is offset from the self-attention window, so that the image classification feature that can accurately represent the visually induced feeling characteristic of the image can be obtained based on the self-attention mechanism. Therefore, image visually induced feeling-based classification can be accurately performed based on the image classification feature, thereby improving accuracy of the image visually induced feeling-based classification.

In an embodiment, the image classification method further includes: determining a trained classification guide model, and performing visually induced feeling-based classification on the sample image using the classification guide model, to obtain a guide model classification result outputted by the classification guide model.

The classification guide model is a pre-trained image classification model. The classification guide model can perform visually induced feeling-based classification on an inputted image, and output a classification result of the visually induced feeling-based classification. A structure of the classification guide model may be different from that of the image classification model. To be specific, training of the image classification model is adjusted based on classification guide models with different model structures, to further improve a feature expression capability of the image classification model. In a specific application, there are various types of visually induced feeling-based classification. For example, for classification processing of discomforting pictures, there are many types of discomforting elements, and classification guide models of different structures may be able to accurately identify different types of discomforting elements. In this case, the training of the image classification model may be guided by using the various classification guide models, so that the image classification model can learn discomforting element classification knowledge of the various classification guide models, thereby improving the accuracy of visually induced feeling-based classification by using the image classification model. The guide model classification result is a classification result obtained by performing visually induced feeling-based classification on the sample image using the classification guide model.

Specifically, the server may obtain a pre-trained classification guide model, such as a BiT model or an Inception V3 model, obtained through training based on convolutional neural networks (CNNs). The server performs visually induced feeling-based classification on the sample image using the classification guide model. Specifically, the server may input the sample image into the classification guide model, and the classification guide model performs visually induced feeling-based classification on the sample image, and outputs the guide model classification result.

Further, the updating a model parameter of the image classification model based on the classification result of the visually induced feeling-based classification, to obtain a target image classification model after training includes: determining a training loss of the image classification model according to the classification result of the visually induced feeling-based classification and the guide model classification result; and updating the model parameter of the image classification model based on the training loss, to obtain the target image classification model after training.

The training loss is configured for evaluating a degree to which a predicted value of the image classification model differs from a real value. A better training loss generally indicates better performance of the image classification model. Specifically, the server may determine the training loss of the image classification model based on the classification result of the visually induced feeling-based classification and the guide model classification result. For example, the server may determine the training loss according to the difference between the classification result and the guide model classification result. The server updates the model parameter of the image classification model according to the training loss, to obtain the target image classification model after training. A specific form of the loss function corresponding to the training loss may be set according to actual needs. For example, various types of loss functions such as a 0-1 loss function, a square loss function, an absolute value loss function, a logarithmic loss function, and a cross-entropy loss function may be used.

In this embodiment, the server performs visually induced feeling-based classification on the sample images using the trained classification guide model, determines the training loss according to the classification result of the visually induced feeling-based classification and the guide model classification result, and updates the model parameter in the image classification model based on the training loss, to obtain the target image classification model after training. Specifically, the server may continue to perform training on the target image classification model after training until training is completed, to obtain the trained target image classification model. Specifically, when detecting that a training end condition is met, the server may consider that the training is completed, and end the training. For example, it may be considered that the training is completed when a quantity of training times reaches a quantity of training times threshold, or it may be considered that the training is completed when a classification evaluation index of the target image classification model reaches an index threshold. The classification guide model guides the training of the image classification model, which is conducive to improving an expression capability of the image classification model for the visually induced feeling-based classification feature, thereby improving the accuracy of the visually induced feeling-based classification by using the image classification model.

In an embodiment, the determining a training loss of the image classification model according to the classification result of the visually induced feeling-based classification and the guide model classification result includes: determining a visually induced feeling-based classification label of the sample image, and determining a classification loss of the image classification model according to the classification result of the visually induced feeling-based classification and the visually induced feeling-based classification label; determining a distillation loss based on a difference between the classification result of the visually induced feeling-based classification and the guide model classification result; and performing weighted fusion on the classification loss and the distillation loss, to obtain the training loss of the image classification model.

The visually induced feeling-based classification label is configured for identifying a real visually induced feeling type of the sample image, and may be obtained through labeling in advance before training. The classification loss is configured for representing a deviation degree of visually induced feeling-based classification when the image classification model performs visually induced feeling-based classification on the sample images, and is specifically calculated according to a difference between the classification result of the visually induced feeling-based classification and the visually induced feeling-based classification label of the sample image. A specific form of the classification loss may be flexibly set according to actual needs. For example, the classification loss may include, but is not limited to, losses in various forms such as a negative log likelihood loss, a cross-entropy loss, an exponential loss, and a square loss. The distillation loss is configured for representing a deviation degree between classification results of visually induced feeling-based classification performed on the same sample image by using the image classification model and the classification guide model. The distillation loss may be calculated based on the difference between the classification result of the visually induced feeling-based classification and the guide model classification result, and may specifically be in various forms such as a negative log likelihood loss, a cross-entropy loss, an exponential loss, and a square loss. The training loss is obtained through weighted fusion of the classification loss and the distillation loss. Weighted weight parameters during weighted fusion may be set according to actual needs, thereby ensuring effectiveness of the training loss.

Specifically, the server determines the visually induced feeling-based classification label of the sample image, and determines the classification loss according to the classification result of the visually induced feeling-based classification and the visually induced feeling-based classification label. For example, the server may calculate the classification loss based on the difference between the classification result and the visually induced feeling-based classification label. The server determines the difference between the classification result of the visually induced feeling-based classification and the guide model classification result, and calculates the distillation loss based on the difference. For example, the server may calculate the cross-entropy loss based on the difference, to obtain the distillation loss. The server determines respective weighted weights of the classification loss and the distillation loss, and performs weighted fusion on the classification loss and the distillation loss according to the weighted weights. For example, weighted summation may be performed on the classification loss and the distillation loss, to obtain the training loss of the image classification model. The server may update the image classification model based on the training loss, and continue to perform training until the training is completed, to obtain the trained target image classification model.

In a specific application, as shown in FIG. 6, the server inputs the sample image into the image classification model and the classification guide model respectively for visually induced feeling-based classification processing. The image classification model outputs the classification result, and the classification loss may be obtained based on the visually induced feeling-based classification label and the classification result of the sample image. The classification guide model outputs the guide model classification result, and the distillation loss may be obtained based on the visually induced feeling-based classification label of the sample image and the guide model classification result. The server obtains the training loss of the image classification model through weighted fusion of the classification loss and the distillation loss, updates the image classification model based on the training loss, and continues to perform training until the training is completed, to obtain the trained target image classification model.

In this embodiment, the server introduces the distillation loss determined based on the difference between the classification result of the visually induced feeling-based classification and the guide model classification result, and can effectively guide training of the image classification model by the classification guide model using the distillation loss. This is beneficial to improving the expression capability of the image classification model for the visually induced feeling-based classification features, thereby improving the accuracy of the visually induced feeling-based classification by using the image classification model.

In an embodiment, the image classification method further includes: performing image enhancement on the sample image, to obtain an enhanced sample image; and inputting the enhanced sample image into the image classification model for visually induced feeling-based classification, to obtain an enhanced sample classification result outputted by the image classification model.

Image enhancement means performing data enhancement on an image, so that limited data can generate a value equivalent to more data without substantially increasing the data. Specifically, image enhancement may include data enhancement manners such as data enhancement of a geometric transformation type and data enhancement of a color transformation type. The geometric transformation type is performing geometric transformation on an image without changing content of the image, and includes various operations such as flipping, rotating, cropping, morphing, and zooming. The color transformation type can change content of the image itself, and may include various operations such as noising, blurring, color transformation, erasing, and filling. The enhanced sample image is an image obtained by performing image enhancement processing on the sample image. The enhanced sample classification result is a classification result obtained by the image classification model performing visually induced feeling-based classification on the enhanced sample image.

Specifically, the server may perform image enhancement on the sample image, for example, perform geometric transformation on the sample image or add mask noise to the sample image to perform data enhancement, to obtain the enhanced sample image. A specific manner of the image enhancement processing may be flexibly selected based on actual needs. The server performs visually induced feeling-based classification on the enhanced sample image using the image classification model. Specifically, the server inputs the enhanced sample image into the image classification model, and the image classification model outputs the enhanced sample classification result.

Further, the updating a model parameter of the image classification model based on the classification result of the visually induced feeling-based classification, to obtain a target image classification model after training includes: determining a training loss of the image classification model according to the classification result of the visually induced feeling-based classification and the enhanced sample classification result; and updating a model parameter of the image classification model based on the training loss, to obtain the target image classification model after training.

The training loss is configured for evaluating a degree to which a predicted value of the image classification model differs from a real value. Specifically, the server may determine the training loss of the image classification model based on the classification result of the visually induced feeling-based classification and the enhanced sample classification result. For example, the server may determine the training loss according to a difference between the classification result and the enhanced sample classification result. The server updates the model parameter of the image classification model according to the training loss, to obtain the target image classification model after training. Specifically, the server may continue to perform training based on the target image classification model after training until the training is completed, to obtain the trained target image classification model. A specific form of the loss function corresponding to the training loss may be set according to actual needs.

In this embodiment, the server performs image enhancement on the sample image, performs visually induced feeling-based classification on the enhanced sample image obtained through the image enhancement using the image classification model, determines the training loss according to the classification result of the visually induced feeling-based classification and the enhanced sample classification result, and performs updated training on the image classification model based on the training loss. In this way, the training of the image classification model can be guided by using the classification guide model, which is conducive to improving the expression capability of the image classification model for the visually induced feeling-based classification features, thereby improving the accuracy of the visually induced feeling-based classification by using the image classification model.

In an embodiment, the determining a training loss of the image classification model according to the classification result of the visually induced feeling-based classification and the enhanced sample classification result includes: determining a visually induced feeling-based classification label of the sample image, and determining a classification loss of the image classification model according to the classification result of the visually induced feeling-based classification and the visually induced feeling-based classification label; determining a contrastive loss based on a difference between the classification result of the visually induced feeling-based classification and the enhanced sample classification result; and performing weighted fusion on the classification loss and the contrastive loss, to obtain the training loss of the image classification model.

A specific form of the classification loss may be flexibly set according to actual needs, and is configured for representing a deviation degree of visually induced feeling-based classification when visually induced feeling-based classification is performed on the sample image using the image classification model. Specifically, the classification loss is calculated according to the difference between the classification result of the visually induced feeling-based classification and the visually induced feeling-based classification label of the sample image. The contrastive loss is configured for representing a deviation degree between classification results of visually induced feeling-based classification performed by the image classification model on the sample image and the corresponding enhanced sample image. The contrastive loss may be calculated based on the difference between the classification result of the visually induced feeling-based classification and the enhanced sample classification result, and may specifically be in various forms such as a negative log likelihood loss, a cross-entropy loss, an exponential loss, and a square loss. The training loss is obtained through weighted fusion of the classification loss and the contrastive loss. Weighted weight parameters during weighted fusion may be set according to actual needs, thereby ensuring effectiveness of the training loss.

Specifically, the server determines the visually induced feeling-based classification label of the sample image, and determines the classification loss according to the classification result of the visually induced feeling-based classification and the visually induced feeling-based classification label. For example, the server may calculate the classification loss based on the difference between the classification result and the visually induced feeling-based classification label. The server determines the difference between the classification result of the visually induced feeling-based classification and the enhanced sample classification result, and calculates the contrastive loss based on the difference. The contrast loss is configured for representing a visually induced feeling-based classification difference corresponding to the image classification model before and after image enhancement is performed on the sample image. For example, a cross-entropy loss may be calculated based on the difference, to obtain the contrast loss. The server determines respective weighted weights of the classification loss and the contrastive loss. The weighted weights may be set in advance according to actual needs, for example, may be set based on experimental values of a plurality of experiments. The server performs weighted fusion on the classification loss and the contrastive loss according to the weighted weights, for example, may perform weighted summation on the classification loss and the contrastive loss, to obtain the training loss of the image classification model. The server may update the image classification model based on the training loss, and continue to perform training until the training is completed, to obtain the trained target image classification model.

In this embodiment, the server performs visually induced feeling-based classification on the sample image and the corresponding enhanced sample image using the image classification model, determines the contrastive loss based on the difference between classification results of the sample image and the corresponding enhanced sample image, and introduces the contrastive loss to effectively disturb training of the image classification model, which is conducive to improving the feature expression capability and robustness of the image classification model, and ensuring the accuracy of the visually induced feeling-based classification by using the image classification model.

In an embodiment, the image classification method further includes: determining an enhanced sample classification loss of the image classification model according to the enhanced sample classification result and the visually induced feeling-based classification label.

The enhanced sample classification loss is calculated according to a difference between the enhanced sample classification result and the visually induced feeling-based classification label of the sample image, and is configured for representing a deviation degree of visually induced feeling-based classification when visually induced feeling-based classification is performed on the enhanced sample image using the image classification model. A specific form of the enhanced sample classification loss may be flexibly set according to actual needs.

Specifically, the server determines the difference between the enhanced sample classification result and the visually induced feeling-based classification label of the sample image, and calculates the enhanced sample classification loss based on the difference in a preset form of a loss function.

Further, the performing weighted fusion on the classification loss and the contrastive loss, to obtain the training loss of the image classification model includes: performing weighted fusion on the classification loss, the enhanced sample classification loss, and the contrastive loss, to obtain the training loss of the image classification model.

Specifically, the server determines respective weighted weights of the classification loss, the enhanced sample classification loss, and the contrastive loss. The weighted weight may be preset according to actual needs, for example, may be set based on experimental values of a plurality of experiments. The server performs weighted fusion on the classification loss, the enhanced sample classification loss, and the contrastive loss according to the weighted weights, for example, may perform weighted summation on the classification loss, the enhanced sample classification loss, and the contrastive loss, to obtain the training loss of the image classification model. The server may update the image classification model based on the training loss, and continue to perform training until the training is completed, to obtain the trained target image classification model.

In this embodiment, the server performs visually induced feeling-based classification on the enhanced sample image of the sample image using the image classification model, determines the enhanced sample classification loss according to the enhanced sample classification result, and obtains the training loss of the image classification model by combining the classification loss and the contrast loss. In this way, the enhanced sample classification loss and the contrast loss are introduced to effectively disturb the training of the image classification model, which is conducive to improving the feature expression capability and the robustness of the image classification model, and ensuring the accuracy of the visually induced feeling-based classification by using the image classification model.

In an embodiment, the performing image enhancement on the sample image to obtain an enhanced sample image includes: generating a mask image, an image size of the mask image matching an image size of the sample image; and fusing the mask image and the sample image, to obtain the enhanced sample image.

The mask image can mask some areas of the image, so that the areas do not participate in processing or calculation of processing parameters, thereby obtaining different images, and implementing data enhancement processing on the image. An image size of the mask image matches that of the sample image, and specifically, may be the same as that of the sample image, so that adaptive fusion can be performed on the mask image and the sample image.

Specifically, the server generates the mask image, where the image size of the mask image matches that of the sample image. Specifically, the server may generate, according to the image size of the sample image and based on a GridMask image enhancement manner, a mask image with a random size and being blocked at a random position. The server fuses the mask image and the sample image. Specifically, the mask image and the sample image may be fused by overlapping pixels in the mask image with pixels at corresponding positions in the sample image, to obtain the enhanced sample image.

In this embodiment, the server fuses the mask image and the sample image to obtain the enhanced sample image, to perform image enhancement processing on the sample image, which can add slight disturbance to the sample image. The model training based on the enhanced sample image can ensure a generalization ability of the image classification model, and ensure the accuracy of the visually induced feeling-based classification by using the image classification model.

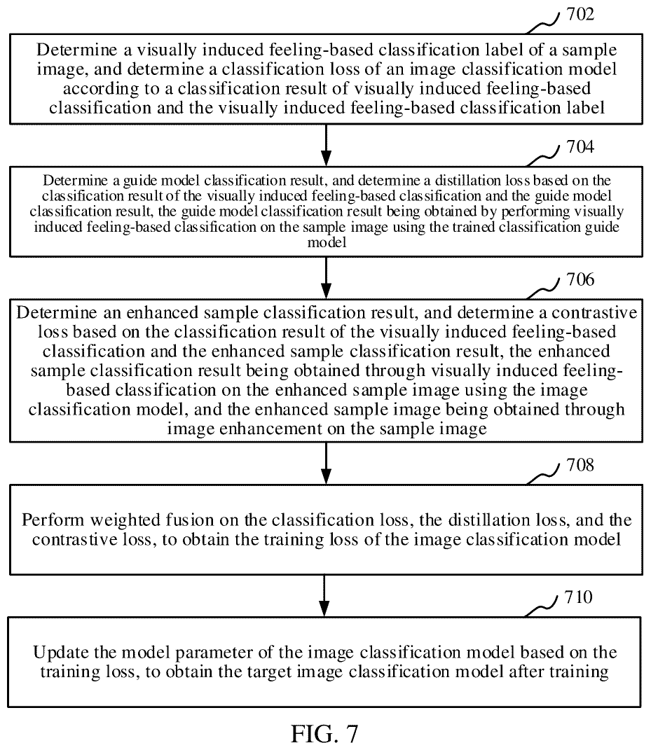

In an embodiment, as shown in FIG. 7, model updating processing, to be specific, updating a model parameter of the image classification model based on the classification result of the visually induced feeling-based classification, to obtain a target image classification model after training includes the following operations:

Operation 702: Determine a visually induced feeling-based classification label of the sample image, and determine a classification loss of the image classification model according to the classification result of the visually induced feeling-based classification and the visually induced feeling-based classification label.

The classification loss is configured for representing a deviation degree of visually induced feeling-based classification when visually induced feeling-based classification is performed on the sample image using the image classification model. Specifically, the server determines the visually induced feeling-based classification label of the sample image, and determines the classification loss according to the classification result of the visually induced feeling-based classification and the visually induced feeling-based classification label. For example, the server may calculate the classification loss based on the difference between the classification result and the visually induced feeling-based classification label.

Operation 704: Determine a guide model classification result, and determine a distillation loss based on the classification result of the visually induced feeling-based classification and the guide model classification result, the guide model classification result being obtained by performing visually induced feeling-based classification on the sample image using the trained classification guide model.

The classification guide model is a pre-trained image classification model. The classification guide model can perform visually induced feeling-based classification on an inputted image, and output a classification result of the visually induced feeling-based classification. The distillation loss is configured for representing a deviation degree between classification results of visually induced feeling-based classification performed on the same sample image by using the image classification model and the classification guide model.

Specifically, the server determines the difference between the classification result of the visually induced feeling-based classification and the guide model classification result, and calculates the distillation loss based on the difference. For example, the server may calculate the cross-entropy loss based on the difference, to obtain the distillation loss.

Operation 706: Determine an enhanced sample classification result, and determine a contrastive loss based on the classification result of the visually induced feeling-based classification and the enhanced sample classification result, the enhanced sample classification result being obtained through visually induced feeling-based classification on the enhanced sample image using the image classification model, and the enhanced sample image being obtained through image enhancement on the sample image.

The enhanced sample image is an image obtained by performing image enhancement processing on the sample image. The enhanced sample classification result is a classification result obtained by the image classification model performing visually induced feeling-based classification on the enhanced sample image. The contrastive loss may be calculated based on a difference between the classification result of the visually induced feeling-based classification and the enhanced sample classification result.

Specifically, the server determines the difference between the classification result of the visually induced feeling-based classification and the enhanced sample classification result, and calculates the contrastive loss based on the difference. For example, the server may calculate the cross-entropy loss based on the difference, to obtain the contrastive loss.

Operation 708: Perform weighted fusion on the classification loss, the distillation loss, and the contrastive loss, to obtain the training loss of the image classification model.

Specifically, the server determines respective weighted weights of the classification loss, the distillation loss, and the contrastive loss, and performs weighted fusion on the classification loss, the distillation loss, and the contrastive loss according to the weighted weights. For example, weighted summation may be performed on the classification loss, the distillation loss, and the contrastive loss, to obtain the training loss of the image classification model. The server may perform updated training on the image classification model based on the training loss.

Operation 710: Update the model parameter of the image classification model based on the training loss, to obtain the target image classification model after training.

Specifically, the server updates the model parameter of the image classification model based on the obtained training loss. For example, the model parameter of the image classification model can be updated based on the gradient descent method. The server continues to perform training on the updated image classification model until the training is completed, to obtain the trained target image classification model.

In this embodiment, the server introduces the distillation loss determined based on the difference between the classification result of the visually induced feeling-based classification and the guide model classification result, and can effectively guide training of the image classification model by the classification guide model using the distillation loss. This is beneficial to improving the expression capability of the image classification model for the visually induced feeling-based classification features. In addition, the server performs visually induced feeling-based classification on the sample image and the corresponding enhanced sample image using the image classification model, determines the contrastive loss based on the difference between classification results of the sample image and the corresponding enhanced sample image, and introduces the contrastive loss to effectively disturb training of the image classification model, which is conducive to improving the feature expression capability and the robustness of the image classification model, and improving the accuracy of the visually induced feeling-based classification by using the image classification model.

In an embodiment, the window size of the self-attention window and the size of the feature patch in the target feature map inputted at the layer satisfy a size matching relationship, and the extracting an intermediate feature of a covered feature patch according to the self-attention window includes: sequentially moving the self-attention window in the target feature map, and respectively extracting a moving window feature of each feature patch covered by the self-attention window during the movement; performing residual fusion on the moving window feature to obtain a fused moving window feature; and sequentially performing fully-connected mapping and residual fusion on the fused moving window feature, to obtain the intermediate feature.

The window size of the self-attention window and the size of the feature patch in the target feature map inputted at the layer satisfy the size matching relationship, and the size matching relationship may specifically be that the self-attention window covers a specific quantity of feature patches. For example, the self-attention window may cover 16 feature patches. In this case, a width and a height of the self-attention window are respectively 4 times a width and a height of the covered feature patch. In this case, when the size of the feature patch changes, the window size of the self-attention window also changes accordingly. For example, when the size of the feature patch is 4 pixels×4 pixels, the window size of the self-attention window may be 16 pixels×16 pixels, and the self-attention window may cover 16 feature patches. When the feature patch becomes 8 pixels×8 pixels through a merging operation, the window size of the self-attention window becomes 32 pixels×32 pixels, and the self-attention window may still cover 16 feature patches. The moving window feature is a self-attention feature obtained by sequentially extracting the self-attention feature in a moving process of the self-attention window in the target feature map. Residual fusion means processing of adding a residual, and fusing the target feature map inputted at the layer with the moving window feature. Through residual fusion, problems of gradient diffusion and gradient explosion can be effectively resolved, and a problem of degradation of the image classification model in the training process is avoided, so that the feature expression capability of the image classification model is ensured. The fully-connected mapping may be mapping processing implemented based on a fully-connected layer. Each node of the fully-connected layer is connected to all nodes of an upper layer, and the fully-connected layer is configured to synthesize features extracted before.

Specifically, the server may determine the self-attention window using the image classification model, the window size of the self-attention window having a matching relationship with the size of the feature patch in the target feature map inputted at the layer. The server sequentially moves the self-attention window in the target feature map using the image classification model. Specifically, non-overlapping window movement may be performed, to ensure that feature patches covered by the self-attention window before and after the movement do not overlap. The server determines the feature patch covered by the self-attention window in the target feature map during the movement, and performs self-attention feature extraction based on the covered feature patch, to obtain the moving window feature. The server performs residual fusion on the moving window feature using the image classification model to obtain a fused moving window feature, performs fully-connected mapping based on the fused moving window feature, and then performs residual fusion again, to obtain the intermediate feature in combined processing of the layer.

In this embodiment, the self-attention window is sequentially moved in the target feature map, and self-attention feature extraction is performed on the covered feature patch during the movement. Then, residual fusion is performed on the moving window feature, and fully-connected mapping and residual fusion are sequentially performed based on the fused moving window feature, to obtain the intermediate feature. Local self-attention feature extraction may be performed by using the self-attention window. While a data processing amount is reduced, an accurate intermediate feature is obtained based on the self-attention mechanism, which is conducive to improving the accuracy of the image classification processing based on the intermediate feature.

In an embodiment, the extracting the intermediate feature according to the offset window, to obtain a feature map outputted at the layer includes: sequentially moving the offset window in the intermediate feature, and respectively extracting an offset window feature of a feature patch covered by the offset window during the movement; performing residual fusion on the offset window feature to obtain a fused offset window feature; and sequentially performing fully-connected mapping and residual fusion on the fused offset window feature, to obtain the feature map outputted at the layer.

The offset window is obtained by offsetting the self-attention window, and specifically, may be obtained by offsetting the self-attention window by a preset distance in a preset direction. The offset window feature is a self-attention feature obtained by sequentially extracting the self-attention feature in a moving process of the offset window in the intermediate feature. Residual fusion means processing of adding a residual, and fusing the intermediate feature with the offset window feature. Through residual fusion, problems of gradient diffusion and gradient explosion can be effectively resolved, and a problem of degradation of the image classification model in the training process is avoided, so that the feature expression capability of the image classification model is ensured. The fully-connected mapping may be mapping processing implemented based on a fully-connected layer.

Specifically, the server may determine, using the image classification model, the offset window that is offset from the self-attention window, and a window size of the offset window is consistent with a window size of the self-attention window. The server sequentially moves the offset window in the intermediate feature using the image classification model. Specifically, non-overlapping window movement may be performed, to ensure that feature patches covered by the offset window before and after the movement do not overlap. The server determines the feature patch covered by the offset window in the intermediate feature during the movement, and performs self-attention feature extraction based on the covered feature patch, to obtain the offset window feature. The server performs residual fusion on the offset window feature using the image classification model to obtain a fused offset window feature, and sequentially performs fully-connected mapping and residual fusion based on the fused offset window feature, to obtain the feature map outputted at the layer.

In this embodiment, the offset window that is offset from the self-attention window is sequentially moved in the intermediate feature, and the self-attention feature extraction is performed on the covered feature patch during the movement. Then, residual fusion is performed on the offset window feature, and fully-connected mapping and residual fusion are sequentially performed based on the fused offset window feature, to obtain the feature map outputted at the layer. This can implement information interaction between different windows through the offset window, which is conducive to obtaining the accurate image classification feature, thereby improving the accuracy when image classification processing is performed based on the intermediate feature.

In an embodiment, the at least one layer includes a plurality of layers, and the performing combined processing of at least one layer on the feature map using the image classification model, to obtain a combined-processed feature map outputted through the combined processing of the at least one layer includes: determining a layer-specific self-attention window using the image classification model, a window size of the layer-specific self-attention window matching a size of a feature patch in a feature map inputted at the first layer, extracting a layer-specific intermediate feature of a covered layer-specific feature patch according to the layer-specific self-attention window, the covered layer-specific feature patch being a feature patch covered by the layer-specific self-attention window in the feature map, determining a layer-specific offset window that is offset from the layer-specific self-attention window, and extracting the layer-specific intermediate feature according to the layer-specific offset window that is offset, to obtain a feature map outputted at the first layer; and performing, at each layer starting from the second layer, combined processing at the layer on a feature map outputted at a previous layer, to obtain a feature map outputted at the layer, until a combined-processed feature map of the plurality of layers is outputted through combined processing at the last layer.

The layer-specific self-attention window is a self-attention window on which self-attention feature extraction is performed in combined processing of the first layer. The layer-specific intermediate feature is an intermediate feature obtained through the self-attention feature extraction of the layer-specific self-attention window. The layer-specific offset window is an offset window that is offset from the layer-specific self-attention window.

Specifically, the at least one layer includes a plurality of layers, and may specifically be at least two layers. To be specific, for the combined processing of the plurality of layers performed on the feature map, in combined processing of the first layer, the server performs, using the image classification model according to a layer-specific self-attention window whose window size matches the size of the feature patch in the feature map inputted at the first layer, self-attention feature extraction on a layer-specific feature patch covered by the layer-specific self-attention window in the feature map, to obtain a layer-specific intermediate feature, and performs self-attention feature extraction on the layer-specific intermediate feature according to a layer-specific offset window that is offset from the layer-specific self-attention window, to obtain the feature map outputted at the first layer. That is, for the combined processing of the first layer, the feature map of the sample image is directly used as the inputted feature map for combined processing, to output the feature map of the first layer. For each layer starting from the second layer, the server performs, using the image classification model, combined processing of the layer on a feature map outputted at a previous layer, to obtain a feature map outputted at the layer, until the combined-processed feature map of the plurality of layers is outputted through combined processing at the last layer. That is, for each layer starting from the second layer, a feature map outputted at a previous layer may be used as an inputted feature map for combined processing, and a feature map outputted at the layer may be used as an inputted feature map at the next layer, until combined processing of the last layer is completed, to output combined-processed feature map of the plurality of layers.

In this embodiment, the server performs the combined processing of the plurality of layers based on the feature map of the sample image using the image classification model, so that deep-layer visually induced feeling-based classification feature extraction can be performed on the sample image, which is conducive to obtaining features that can accurately express visually induced feeling-based classification characteristics of the image, thereby improving the accuracy of the image classification processing.

In an embodiment, the performing, at each layer starting from the second layer, combined processing at the layer on a feature map outputted at a previous layer, to obtain a feature map outputted at the layer includes: merging, at each layer starting from the second layer, when the layer meets a feature patch merging condition, feature patches in the feature map outputted at the previous layer, to obtain a merged feature map; and performing combined processing at the layer on the merged feature map, to obtain the feature map outputted at the layer.

The feature patch merging condition is configured for determining whether feature patches in a feature map outputted through combined processing of the previous layer need to be merged, to perform combined processing according to feature patches with different size ranges. The feature patch merging condition may be set according to actual needs. Specifically, the feature patch merging condition may be whether a quantity of combined processing times on feature patches with a specific size reaches a quantity of times threshold. When the quantity of times threshold is reached, it is considered that the feature patch merging condition is satisfied, to trigger merging of the feature patches. The merged feature map is a feature map obtained by merging the feature patches in the feature map outputted at the previous layer. Specifically, merging may be performed according to a specific merging rule, for example, merging is performed on every four feature patches according to the quantity, so that every four feature patches are merged into one new large-sized feature patch.

Specifically, during the combined processing of the plurality of layers, the combined processing does not change the size of the feature patch. To increase ranges of different receptive fields, the feature patches may be merged, and then combined processing is performed. In this way, the combination processing is performed under conditions of different feature patch sizes, to obtain richer features. The server may determine a size of the feature patch in each time of combined processing. If a quantity of times of combined processing performed on a feature patch with a specific size reaches a quantity of times threshold, it is considered that the layer satisfies the feature patch merging condition. In this case, the feature patches in the feature map outputted at the previous layer can be merged to obtain the merged feature map. The server may perform combined processing of the layer based on the merged feature map, to be specific, may use the merged feature map as an inputted feature map of the layer to perform combined processing of the layer, to obtain a feature map outputted at the layer.

In this embodiment, in a case that the feature patch merging condition is satisfied, the feature patches in the feature map outputted at the previous layer are merged, and the combined processing at the layer is performed based on the obtained merged feature map, so that the size of the feature patch can be changed, and the combined processing is performed under conditions of different feature patch sizes, resulting in richer image features, which is beneficial to improving the accuracy of the image classification processing.

In an embodiment, the mapping a plurality of image patches in a sample image using an image classification model, to obtain a feature map of the sample image including: dividing the sample image using the image classification model to obtain the plurality of image patches; mapping the plurality of image patches respectively using the image classification model, to obtain respective image patch mapping features of the plurality of image patches; determining respective position features of the plurality of image patches using the image classification model according to respective distribution positions of the plurality of image patches in the sample image; and respectively merging the respective image patch mapping features and the respective position features of the plurality of image patches using the image classification model, to obtain respective feature patches of the plurality of image patches.

The image patch is obtained by performing patch division on the sample image, and the image patch mapping feature is a feature obtained through feature mapping on the image patch. The distribution position is a position of the image patch in the sample image, and different image patches correspond to different distribution positions. The position feature is obtained through mapping based on the distribution position of the image patch, and is configured for representing a position of the image patch in the sample image. The feature patch is obtained by merging the image patch mapping feature and the respective position feature, and may reflect both a feature of the image patch and a distribution position characteristic of the image patch in the sample image.

Specifically, the server may perform image patch division on the sample image using the image classification model. For example, the image patch division may be performed based on a preset size, to obtain the plurality of image patches in the sample image. The server performs feature mapping on the plurality of image patches respectively using the image classification model, to obtain respective image patch mapping features of the plurality of image patches. For example, the server may use a linear embedding layer structure in the image classification model to perform feature mapping on the plurality of image patches respectively, to obtain respective linear embedding features of the plurality of image patches. The server determines respective distribution positions of the plurality of image patches in the sample image, and determines respective position features of the plurality of image patches based on the distribution positions using the image classification model. For example, feature mapping may be performed based on the distribution positions, to obtain the respective position features of the plurality of image patches. The server merges the respective image patch mapping features and the respective position features of the plurality of image patches using the image classification model. Specifically, the server may merge the image patch mapping features and the position features according to the same dimension, to obtain the respective feature patches of the plurality of image patches. Dimensions of the feature patches are the same as dimensions of the image patch mapping features and the position features, that is, a quantity of dimensions of the features is not increased. Feature maps of the sample image may be obtained according to the respective feature patches of the plurality of image patches, so that the combined processing the at least one layer is performed based on the feature map.

In this embodiment, the server divides the sample image into the plurality of image patches using the image classification model, and merges the respective image patch mapping features and the respective position features of the plurality of image patches, to obtain the respective feature patches of the plurality of image patches. In this way, the feature patch carrying the distribution position and the characteristic of the image patch can be obtained, which can accurately express the characteristic of the image patch, and is conducive to improving the accuracy of the image classification processing.

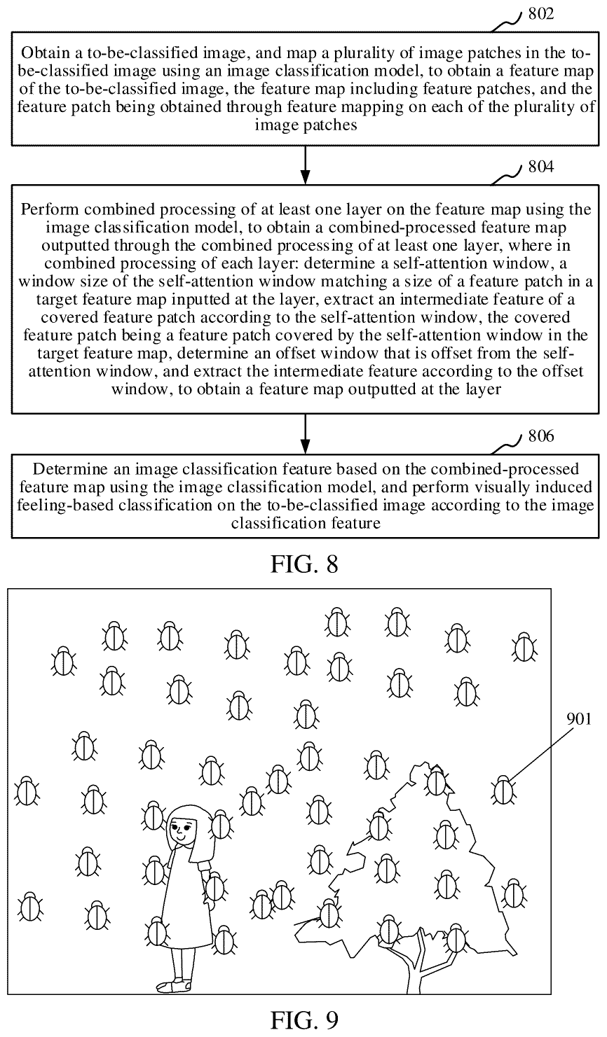

In an embodiment, as shown in FIG. 8, an image classification method is provided. The method is performed by a computer device. Specifically, the method may be separately performed by a computer device such as a terminal or a server, or may be jointly performed by the terminal and the server. In this embodiment of this disclosure, an example in which the method is applied to the server in FIG. 1 is used as an example for description. The method includes the following operations:

Operation 802: Obtain a to-be-classified image, and map a plurality of image patches in the to-be-classified image using an image classification model, to obtain a feature map of the to-be-classified image, the feature map including feature patches, and the feature patch being obtained through feature mapping on each of the plurality of image patches.

The to-be-classified image is an image on which image classification processing needs to be performed. The image classification model may be a pre-trained model configured for performing visually induced feeling-based classification on the inputted image. The image classification model may be constructed in different structures according to actual needs. For example, image classification models with different layer structures may be constructed based on a Transformer algorithm. The image patches are obtained by dividing the to-be-classified image, and a size of the image patch may be set according to actual needs. The feature patches are obtained through feature mapping on the image patches in the to-be-classified image, and the feature patch represents an image classification characteristic of the image patch. The to-be-classified image is divided into a plurality of image patches. A corresponding feature patch may be obtained through feature mapping on each image patch respectively, and the feature map of the to-be-classified image may be obtained by combining the feature patches.

Specifically, the server obtains a to-be-classified image that needs to be classified, and the server performs feature mapping on a plurality of image patches in the to-be-classified image using the pre-trained image classification model. Specifically, the to-be-classified image may be inputted into the image classification model, so that an image division layer structure in the image classification model perform patch division on the inputted to-be-classified image, to obtain a plurality of image patches. Then, a feature mapping layer in the image classification model performs feature mapping on each image patch. For example, a feature extraction layer structure set according to a preset algorithm may perform feature extraction on each image patch, to obtain feature patches respectively corresponding to the plurality of image patches in the to-be-classified image. The image classification model obtains the feature map of the to-be-classified image based on the feature patches corresponding to the plurality of image patches.

Operation 804: Perform combined processing of at least one layer on the feature map using the image classification model, to obtain a combined-processed feature map outputted through the combined processing of the at least one layer, where in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract the intermediate feature according to the offset window, to obtain a feature map outputted at the layer.

Specifically, the server performs combined processing of at least one layer on the feature map using the image classification model, to obtain the combined-processed feature map outputted through the combined processing of the at least one layer. For example, at least one combined processing layer in the image classification model may perform combined processing to obtain the combined-processed feature map. In the combined processing of each layer, the image classification model determines a self-attention window whose window size matches a size of a feature patch in the target feature map inputted at the layer, determines a covered feature patch in the target feature map according to the self-attention window, and performs self-attention feature extraction on the covered feature patch, to obtain the intermediate feature. The self-attention window may cover a local area in the target feature map. By constantly moving the self-attention window, self-attention feature extraction on various feature patches in the target feature map can be implemented. The image classification model offsets the self-attention window to obtain the offset window, and performs self-attention feature extraction on the intermediate feature according to the offset window. Specifically, a feature patch covered by the offset window in the intermediate feature may be determined, and self-attention feature extraction may be performed on the feature patch covered by the offset window, to obtain a feature map outputted at the layer, thereby implementing the combined processing of the layer. In the combined processing of a plurality of layers, the feature map outputted through the combined processing of the layer is used as a feature map inputted to combined processing of a next layer, to perform the combined processing of the next layer on the feature map outputted through the combined processing of the layer, to implement combined processing of a plurality of layers, and obtain the combined-processed feature map.

Operation 806: Determine an image classification feature based on the combined-processed feature map using the image classification model, and perform visually induced feeling/perception-based classification on the to-be-classified image according to the image classification feature.

Specifically, the server determines the image classification feature using the image classification model based on the combined-processed feature map. For example, an obtained combined-processed feature may be directly used as the image classification feature, or the image classification feature may be obtained by further performing feature mapping optimization processing on the combined-processed feature. The server performs visually induced feeling/perception-based classification according to the image classification feature, so that the classification result of the visually induced feeling/perception-based classification can be obtained. The classification result may be determined based on a type into which the sample image needs to be classified in the visually induced feeling/perception-based classification. For example, if the visually induced feeling/perception-based classification includes two types: discomforting and non-discomforting, the classification result may be configured for representing whether the to-be-classified image belongs to a discomforting image. The visually induced feeling/perception-based classification may alternatively include specific visually induced feeling/perception types, for example, may include four types: happiness, anger, fear, and sadness. In this case, the classification result may be configured for representing an image of which visually induced feeling/perception type the to-be-classified image specifically belongs to.

In the foregoing image classification method, combined processing of at least one layer is performed using the image classification model based on a feature map of the to-be-classified image, to obtain a combined-processed feature map. In combined processing of each layer, according to a self-attention window whose window size matching a size of a feature patch in a target feature map inputted at the layer, self-attention feature extraction is performed on a feature patch covered by the self-attention window in the target feature map; according to an offset window that is offset from the self-attention window, self-attention feature extraction is performed on an obtained intermediate feature, to obtain a feature map outputted at the layer; and visually induced feeling/perception-based classification is performed based on an image classification feature determined based on the combined-processed feature map. During classification processing of the to-be-classified image, in the combined processing of each layer of the image classification model, self-attention feature extraction is sequentially performed through the self-attention window matching the size of the feature patch in the target feature map inputted at the layer and the offset window that is offset from the self-attention window, so that the image classification feature that can accurately represent the visually induced feeling/perception characteristic of the image can be obtained based on the self-attention mechanism. Therefore, image visually induced feeling/perception-based classification can be accurately performed based on the image classification feature, thereby improving accuracy of the image visually induced feeling/perception-based classification.

In an embodiment, the image classification method further includes: obtaining a visually induced feeling/perception-based classification result of the to-be-classified image, and determining, according to the visually induced feeling/perception-based classification result, a visually induced feeling/perception attribute of content to which the to-be-classified image belongs; determining attribute information of the content, and updating the visually induced feeling/perception attribute to the attribute information; and determining account information of an account, and recommending content to the account based on the attribute information of the content and the account information.

Content to which the to-be-classified image belongs may be various forms of resource content, such as an article, a web page, a video, or an image. That the to-be-classified image belongs to the content means that the to-be-classified image may be an image extracted from the content. For example, the to-be-classified image may be an image extracted from a web page, or may be a video frame extracted from a video. The visually induced feeling/perception attribute may be used as attribute information of content, and is configured for representing a type of a visually induced feeling/perception of people when browsing the content. The account may be an account of a user. When content is recommended to the user, content recommendation may be accurately performed based on the account information, such as historical browsing information and an account interest label, of the user account bound to the user.

Specifically, the server obtains the visually induced feeling/perception-based classification result of the to-be-classified image, and determines the content to which the to-be-classified image belongs. The server determines the visually induced feeling/perception attribute of the content based on the visually induced feeling/perception-based classification result. Specifically, the visually induced feeling/perception label may be added to the content. For example, when the visually induced feeling/perception-based classification result reflects that the to-be-classified image belongs to a discomforting picture with a sense of visual discomfort, the server may add a “discomforting” label to corresponding content. The server updates the visually induced feeling/perception attribute to the attribute information of the corresponding content, so that the visually induced feeling/perception attribute is used as the attribute information of the content and is bound to the content. the server performs content recommendation for the account based on the attribute information of the content and the account information of the account. Specifically, the server may perform feature matching on the attribute information of the content and the account information of the account, to determine whether the content belongs to content of interest to the account, to perform content recommendation for the account, and specifically, may recommend the content to the account. For example, if the account is owned by a juvenile user, and the visually induced feeling/perception attribute in the attribute information of the content is discomforting, when content recommendation is performed for the account, the content needs to be targeted blocked, to avoid generating a sense of discomfort to the user owning the account.

In this embodiment, the server determines the visually induced feeling/perception attribute of the content to which the to-be-classified image belongs based on the visually induced feeling/perception-based classification result of the to-be-classified image, updates the visually induced feeling/perception attribute to the attribute information of the content, and performs content recommendation for the account based on the attribute information of the content and the account information of the account, so that content recommendation that is targeted in the visually induced feeling/perception dimension can be performed, which is beneficial to improving pertinence of the content recommendation, and effectively avoids causing discomfort to the user owning the account, thereby ensuring user experience.

This disclosure further provides an application scenario. In the application scenario, the foregoing image classification method is applied. Specifically, the foregoing image classification method and application of the image classification method in the application scenario are as follows:

When filtering resource content on the Internet, the server performs combined processing of at least one layer using an image classification model based on a feature map of the sample image, to obtain a combined-processed feature map. In combined processing of each layer, the server performs, according to a self-attention window whose window size matching a size of a feature patch in a target feature map inputted at the layer, self-attention feature extraction on a feature patch covered by the self-attention window in the target feature map; performs, according to an offset window that is offset from the self-attention window, self-attention feature extraction on an obtained intermediate feature to obtain a feature map outputted at the layer; performs visually induced feeling/perception-based classification based on an image classification feature determined based on the combined-processed feature map; and continues to perform training after updating the image classification model based on a classification result of the visually induced feeling/perception-based classification, until training is completed to obtain a trained target image classification model. For a trained target image classification model, the server extracts target images from the resource content on the Internet, and the server performs combined processing of at least one layer using the image classification model based on a feature map of the target image, to obtain a combined-processed feature map. In combined processing of each layer, the server performs, according to a self-attention window whose window size matching a size of a feature patch in a target feature map inputted at the layer, self-attention feature extraction on a feature patch covered by the self-attention window in the target feature map; performs, according to an offset window that is offset from the self-attention window, self-attention feature extraction on an obtained intermediate feature, to obtain a feature map outputted at the layer; and performs visually induced feeling/perception-based classification based on an image classification feature determined based on the combined-processed feature map. The server adds the corresponding visually induced feeling/perception label to the resource content based on the visually induced feeling/perception-based classification result, so that the resource content can be effectively managed and filtered based on the visually induced feeling/perception dimension, to ensure quality of the resource content on the Internet.

This disclosure further provides an application scenario. In the application scenario, the foregoing image classification method is applied. Specifically, the foregoing image classification method and application of the image classification method in the application scenario are as follows:

With the fast development of the mobile Internet, reading information flows or browsing short videos accounts for a large amount of leisure time of people. Information and video content have varying quality, including some nauseating, disgusting, and thrilling pictures, which significantly affect reading experience of the user. Such pictures may be defined as discomforting pictures. It is important to identify the discomforting pictures for masking or filtering to improve content ecology and improve the reading experience of the user. The image classification method provided in this embodiment may be implemented based on a vision transformer, to effectively identify discomforting pictures. The image classification method provided in this embodiment includes: introducing a vision transformer to pre-train a model Swin, to improve a model representation capability; introducing knowledge distillation to remedy a problem that Swin has insufficient ability in learning local features; and providing a contrastive learning method R-GridMask, to alleviate a phenomenon of Swin overfitting.

For a discomforting picture recognition task, the existing practice is to treat the discomforting picture task as a binary classification or multi-class classification task, and then perform classification by using a CNN model such as BiT or Inception V3. However, when the CNN model is used as a classification model, a model representation capability is easily insufficient. There are miscellaneous types of discomforting pictures. Through analysis of actual business data, the discomforting pictures include a plurality of sub-types, for example, an animal type such as snakes, bugs, and mice; a human body type, such as skin diseases and nauseating teeth; and a virtual type, such as ghosts and zombies. Features of different types are greatly different. If the model representation capability is insufficient, a discomforting element in a picture cannot be accurately identified. Therefore, the discomforting picture task requires a higher representation capability of the model. In addition, when the CNN model is used as the classification model, a global feature is ignored. The CNN model mainly extracts local features of a picture by stacking a plurality of convolutional layers and pooling layers. This mechanism causes the CNN model to easily ignore the global feature. However, the global feature is crucial for the discomforting picture task. As shown in FIG. 9, considering the local features alone, it cannot be determined that a picture is discomforting, because a single bug 901 is small. The global feature needs to be captured, to be specific, when bugs 901 are all over the entire image, it can be determined that the picture is discomforting. Based on this, in the image classification method provided in this embodiment, the vision transformer is introduced to improve the model representation capability, and knowledge distillation is introduced and the R-GridMask mechanism is proposed to further improve a representation capability of the vision transformer. In addition, the vision transformer can well capture the global feature using a self-attention mechanism, to resolve a problem that the CNN network has an insufficient capability in learning the global feature.

A discomforting picture recognition algorithm may be applied to information flow services, such as a news application, a browser, and a short video service. It can mainly identify pictures that are prone to users' discomfort and nausea, such as thrilling pictures and pictures of snakes, ghosts, and bugs. Further, the method may be applied in a personalized recommendation scenario of information flows, to examine pictures at a speed of tens of millions of pictures every day. If a picture or a video carries bloody, nauseating, thrilling, or other discomforting elements, it is a challenge for psychological tolerance of the user. The server may create a discomforting picture label for the picture, which is used as an important feature in the recommendation process, to perform personalized recommendation or downgrading control based on users' preference, to improve user experience.

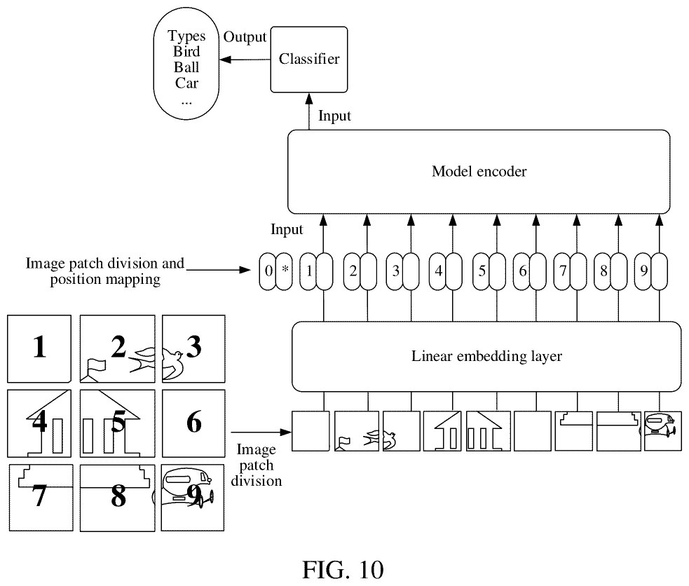

Specifically, a transformer based on the self-attention mechanism has been widely applied in the field of natural language processing (NLP). However, a mainstream model in the visual field is still the CNN model. The currently proposed vision transformer (ViT) model has achieved the state-of-the-art (SOTA) effect on a plurality of image open datasets, exceeding the CNN model, which proves that the transformer has a huge potential in the field of computer vision (CV). As shown in FIG. 10, in processing of the VIT model, a picture (for example, 224*224*3) is divided into a plurality of patches (16*16*3), and the patch is mapped into a patch embedding feature (patch embedding) through a fully-connected layer; an absolute position of the patch in the original image is mapped into a learnable position embedding feature (position embedding); the patch embedding feature (patch embedding) and the position embedding feature (position embedding) are merged as inputs of the transformer model, and are spliced into a randomly initialized CLS vector at a start position as a classification vector; and an output vector of a CLS identifier is spliced to a fully-connected layer by using the self-attention mechanism of the transformer for the classification task. An image is divided into nine patches numbered 1 to 9 respectively. The nine patches are correspondingly inputted into a linear embedding layer (linear projection of flattened patches) for linear mapping, to implement feature mapping on each patch. Each patch is spliced with a randomly initialized CLS vector as a classification vector, and is inputted into a model encoder, to be specific, a transformer encoder, for processing. The transformer encoder outputs classification features to a classifier for classification, and the classification features are specifically classified into various types such as birds, balls, and cars.

The ViT model achieves an effect exceeding that of the CNN in a plurality of visual tasks. However, in improvement of the ViT model, it is considered that the ViT model performs self-attention based on all patches, which has low efficiency. Therefore, the Swin model proposes a manner of performing self-attention based on a divided window. Specifically, an overall structure of the Swin model is similar to that of the ViT model, and the models are both in an encoder structure based on the transformer. The Swin model aggregates neighborhood tokens in a manner of a hierarchical encoder, aiming to learn a convolution operation of the CNN model to enhance a representation capability of local features. The Swin model uses a window division mechanism to divide a picture into a plurality of windows, and performs self-attention only in the windows, which can reduce an amount of calculation, and ensures, through different division manners, that patches in different windows are used to calculate the self-attention in a next iteration process, thereby enhancing the global feature representation capability. The Swin model achieves the best effect on a plurality of visual open datasets. When the Swin model is used as the classification model for the discomforting picture task, because the representation capability of the Swin model is strong enough, the problem of many and miscellaneous sub-types in the discomforting picture task can be well resolved. Moreover, the Swin model can learn the global feature in the discomforting picture well based on the self-attention mechanism. In a specific application, after the Swin model is introduced, when the effect on the discomforting picture task is verified, with the same accuracy, a recall of the Swin model is improved by 6% compared with that of the CNN model and the BiT model; and the recall of the Swin model is improved by 3.6% compared with that of the ViT model, which fully verifies the effectiveness of the Swin model.

Further, with the same accuracy of the discomforting picture task, the recall of the Swin model can be improved by 6% compared with that of the BiT model. The recall calculated herein is an overall recall, and the discomforting picture task includes a plurality of sub-types. When the recall is calculated according to each sub-type, it is found that for most sub-types, the recall of the Swin model increases significantly, but recalls of some sub-types is decrease, for example, a recall of a lizard type decreases by 3.5%, and a recall of bleeding due to heavy injury decreases by 9.1%. It is found through analysis that the convolution operation of the BiT model is more advantageous for some sub-types. Therefore, knowledge distillation is introduced based on the Swin model in view of the practice of a DeiT model. Specifically, the BiT model is first trained on the discomforting picture task, and a classification probability is predicted for pictures in a training set using the trained BIT model. Then, the Swin model is trained. In addition to the conventional classification loss, during training of the Swin model, a distillation loss is introduced, to be specific, a cross-entropy between a probability predicted for the training set using the Swin model and a probability predicted for the training set using the trained BiT model is calculated. Finally, weighted summation is performed on the classification loss and the distillation loss, to jointly perform back-propagation on a gradient to train the network. After knowledge distillation is introduced, the recall of the Swin model is improved by 2.3% while the accuracy of the Swin model is unchanged. In addition, the model structure of the vision transformer can be further optimized by adopting a convolution operation of the CNN-type network, to improve a capability of the model to extract local features. For example, the model structure of the image classification model is optimized through a convolutional layer of the CNN-type network.

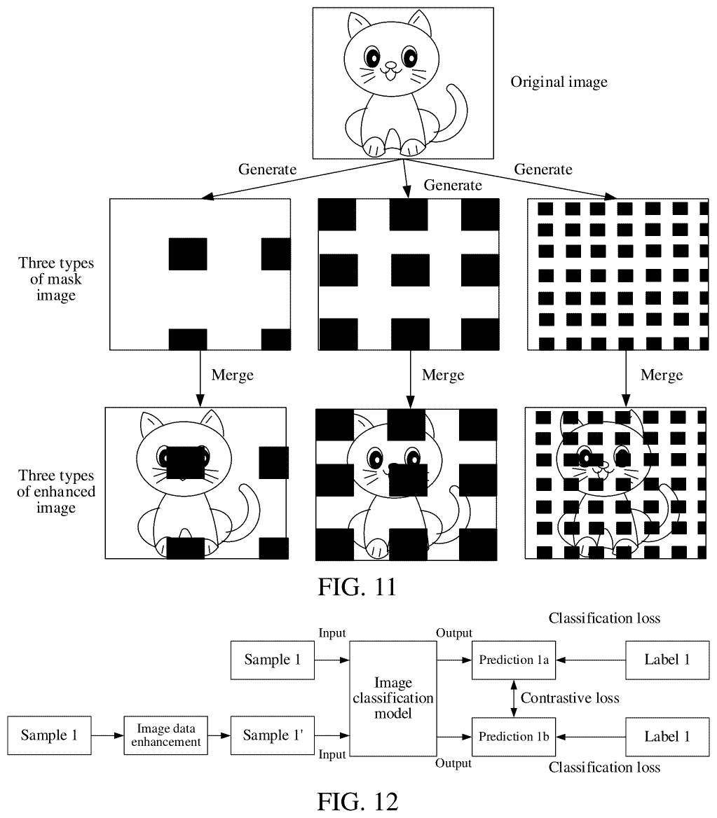

Further, to further improve the representation capability of the image classification model, namely, the Swin model, a contrastive learning method R-GridMask is proposed. The GridMask is an image enhancement mode in which an original image is blocked at a random size and a random position to generate an enhanced picture. As shown in FIG. 11, the original image is a picture of a cat. By generating a mask image with a random size and blocked at a random position. Specifically, three types of different mask images may be obtained, and the three types of mask images are respectively fused with the original image, to obtain three types of enhanced images. A purpose of the R-GridMask is to slightly disturb the image, and the predicted probability of the image after the disturbance caused by the model cannot change too much, to ensure a generalization ability of the model. After the R-GridMask is introduced, the accuracy remains unchanged, and the recall is improved by 2.8%. As shown in FIG. 12, a sample 1 is inputted into an image classification model, to be specific, the Swin model, for training, and a sample 1′ is generated based on the sample 1 in a GridMask enhancement manner. After the two samples are inputted into the Swin model, two predicted probabilities are outputted: a prediction 1a and a prediction 1b. Two losses are calculated based on a label 1 of the sample 1. The first loss is a classification loss calculated based on the label, and the second loss is a calculated contrastive loss, to be specific, Kullback-Leibler divergence/relative entropy is calculated based on the two predicted probabilities outputted by the Swin model, to obtain the contrastive loss. Through the introduced knowledge distillation, weighted summation is performed on the three losses: the classification loss, the distillation loss, and the contrastive loss, to jointly perform back-propagation on a gradient to train the network, and after the training is completed, a target image classification model is obtained. The target image classification model may perform visually induced feeling/perception-based classification on the inputted image, and determine whether the image belongs to a discomforting picture carrying a discomforting element.

In the image classification method provided in this embodiment, the vision transformer performs discomforting picture recognition. The vision transformer has a strong representation capability, and a global feature can also be well captured using the self-attention mechanism. In addition, by introducing the knowledge distillation and image enhancement processing of R-GridMask, the representation capability of the vision transformer can be further improved. The recall rate is significantly improved while the accuracy remains unchanged, which is conducive to accurately perform visually induced feeling/perception-based classification on the pictures.

Although the operations are displayed sequentially according to the instructions of the arrows in the flowcharts of the foregoing embodiments, these operations are not necessarily performed sequentially according to the sequence instructed by the arrows. Unless explicitly specified in this disclosure, execution of the operations is not strictly limited, and the operations may be performed in other sequences. In addition, at least a part of the operations in the flowcharts of the foregoing embodiments may include a plurality of operations or a plurality of stages. These operations or stages are not necessarily performed and completed at the same time, and may be performed at different times. Besides, these operations or stages may be not necessarily performed sequentially, and may be performed in turn or alternately with other operations or at least a part of operations or stages in other operations.

Based on the same inventive concept, an embodiment of this disclosure further provides an image classification apparatus for implementing the foregoing image classification method. An implementation solution to the problem provided by the apparatus is similar to the implementation solution recorded in the foregoing method. Therefore, for specific limitations in one or more embodiments of the image classification apparatus provided below, refer to the limitations on the image classification method above. Details are not described herein again.

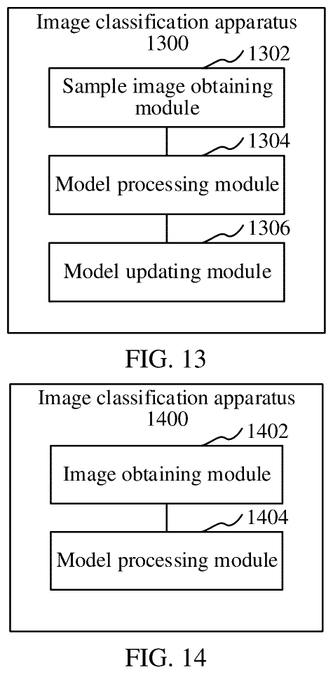

In an embodiment, as shown in FIG. 13, an image classification apparatus 1300 is provided, including: a sample image obtaining module 1302, a model processing module 1304, and a model updating module 1306.

The sample image obtaining module 1302 is configured to: obtain a sample image, and map a plurality of image patches in the sample image using an image classification model, to obtain a feature map of the sample image, the feature map including feature patches, and the feature patch being obtained through feature mapping on each of the plurality of image patches.

The model processing module 1304 is configured to perform combined processing of at least one layer on the feature map using the image classification model, to obtain a combined-processed feature map outputted through the combined processing of the at least one layer, where in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract the intermediate feature according to the offset window, to obtain a feature map outputted at the layer.

The model processing module 1304 is further configured to: determine an image classification feature based on the combined-processed feature map using the image classification model, and perform visually induced feeling/perception-based classification on the sample image according to the image classification feature, to obtain a classification result of the visually induced feeling/perception-based classification.

The model updating module 1306 is configured to update a model parameter of the image classification model based on the classification result of the visually induced feeling/perception-based classification, to obtain a target image classification model after training.

In an embodiment, the apparatus further includes a classification guide model processing module, configured to: determine a trained classification guide model, and perform visually induced feeling/perception-based classification on the sample image using the classification guide model, to obtain a guide model classification result outputted by the classification guide model. The model update module 1306 is further configured to: determine a training loss of the image classification model according to the classification result of the visually induced feeling/perception-based classification and the guide model classification result; and update the model parameter of the image classification model based on the training loss, to obtain the target image classification model after training.

In an embodiment, the model updating module 1306 is further configured to: determine a visually induced feeling/perception-based classification label of the sample image, and determine a classification loss of the image classification model according to the classification result of the visually induced feeling/perception-based classification and the visually induced feeling/perception-based classification label; determine a distillation loss based on a difference between the classification result of the visually induced feeling/perception-based classification and the guide model classification result; and perform weighted fusion on the classification loss and the distillation loss, to obtain the training loss of the image classification model.

In an embodiment, the apparatus further includes an enhanced sample processing module, configured to: perform image enhancement on the sample image, to obtain an enhanced sample image; and input the enhanced sample image into the image classification model for visually induced feeling/perception-based classification, to obtain an enhanced sample classification result outputted by the image classification model. The model update module 1306 is further configured to: determine a training loss of the image classification model according to the classification result of the visually induced feeling/perception-based classification and the enhanced sample classification result; and update the model parameter of the image classification model based on the training loss, to obtain the target image classification model after training.

In an embodiment, the model updating module 1306 is further configured to: determine a visually induced feeling/perception-based classification label of the sample image, and determine a classification loss of the image classification model according to the classification result of the visually induced feeling/perception-based classification and the visually induced feeling/perception-based classification label; determine a contrastive loss based on a difference between the classification result of the visually induced feeling/perception-based classification and the enhanced sample classification result; and perform weighted fusion on the classification loss and the contrastive loss, to obtain the training loss of the image classification model.

In an embodiment, the apparatus further includes an enhanced sample classification loss determining module, configured to determine an enhanced sample classification loss of the image classification model according to the enhanced sample classification result and the visually induced feeling/perception-based classification label. The model update module 1306 is further configured to perform weighted fusion on the classification loss, the enhanced sample classification loss, and the contrastive loss, to obtain the training loss of the image classification model.

In an embodiment, the enhanced sample processing module is further configured to: generate a mask image, an image size of the mask image matching an image size of the sample image; and fuse the mask image and the sample image, to obtain the enhanced sample image.

In an embodiment, the model update module 1306 is further configured to: determine a visually induced feeling/perception-based classification label of the sample image, and determine a classification loss of the image classification model according to the classification result of the visually induced feeling/perception-based classification and the visually induced feeling/perception-based classification label; determine a guide model classification result, and determine a distillation loss based on the classification result of the visually induced feeling/perception-based classification and the guide model classification result, the guide model classification result being obtained by performing visually induced feeling/perception-based classification on the sample image using the trained classification guide model; determine an enhanced sample classification result, and determine a contrastive loss based on the classification result of the visually induced feeling/perception-based classification and the enhanced sample classification result, the enhanced sample classification result being obtained through visually induced feeling/perception-based classification on the enhanced sample image using the image classification model, and the enhanced sample image being obtained through image enhancement on the sample image; perform weighted fusion on the classification loss, the distillation loss, and the contrastive loss, to obtain the training loss of the image classification model; and update the model parameter of the image classification model based on the training loss, to obtain the target image classification model after training.

In an embodiment, the window size of the self-attention window and the size of the feature patch in the target feature map inputted at the layer satisfy a size matching relationship. The model processing module 1304 is further configured to: sequentially move the self-attention window in the target feature map, and respectively extract a moving window feature of each feature patch covered by the self-attention window during the movement; perform residual fusion on the moving window feature to obtain a fused moving window feature; and sequentially perform fully-connected mapping and residual fusion on the fused moving window feature, to obtain the intermediate feature.

In an embodiment, the model processing module 1304 is further configured to: sequentially move the offset window in the intermediate feature, and respectively extract an offset window feature of a feature patch covered by the offset window during the movement; perform residual fusion on the offset window feature to obtain a fused offset window feature; and sequentially perform fully-connected mapping and residual fusion on the fused offset window feature, to obtain the feature map outputted at the layer.

In an embodiment, the at least one layer includes a plurality of layers, and the model processing module 1304 is further configured to: determine a layer-specific self-attention window using the image classification model, a window size of the layer-specific self-attention window matching a size of a feature patch in a feature map inputted at the first layer, extract a layer-specific intermediate feature of a covered layer-specific feature patch according to the layer-specific self-attention window, the covered layer-specific feature patch being a feature patch covered by the layer-specific self-attention window in the feature map, determine a layer-specific offset window that is offset from the layer-specific self-attention window, and extract the layer-specific intermediate feature according to the layer-specific offset window that is offset, to obtain a feature map outputted at the first layer; and perform, at each layer starting from the second layer, combined processing at the layer on a feature map outputted at a previous layer, to obtain a feature map outputted at the layer, until a combined-processed feature map of the plurality of layers is outputted through combined processing at the last layer.

In an embodiment, the model processing module 1304 is further configured to: merge, at each layer starting from the second layer, when the layer meets a feature patch merging condition, feature patches in the feature map outputted at the previous layer, to obtain a merged feature map; and perform combined processing at the layer on the merged feature map, to obtain the feature map outputted at the layer.

In an embodiment, the sample image obtaining module 1302 is further configured to: divide the sample image using the image classification model to obtain the plurality of image patches; map the plurality of image patches respectively using the image classification model, to obtain respective image patch mapping features of the plurality of image patches; determine respective position features of the plurality of image patches using the image classification model according to respective distribution positions of the plurality of image patches in the sample image; and respectively merge the respective image patch mapping features and the respective position features of the plurality of image patches using the image classification model, to obtain respective feature patches of the plurality of image patches.

Based on the same inventive concept, an embodiment of this disclosure further provides an image classification apparatus for implementing the foregoing image classification method. An implementation solution to the problem provided by the apparatus is similar to the implementation solution recorded in the foregoing method. Therefore, for specific limitations in one or more embodiments of the image classification apparatus provided below, refer to the limitations on the image classification method above. Details are not described herein again.

In an embodiment, as shown in FIG. 14, an image classification apparatus 1400 is provided, including: a target image obtaining module 1402 and a model processing module 1404.

The image obtaining module 1402 is configured to: obtain a to-be-classified image, and map a plurality of image patches in the to-be-classified image using an image classification model, to obtain a feature map of the to-be-classified image, the feature map including feature patches, and the feature patch being obtained through feature mapping on each of the plurality of image patches.

The model processing module 1404 is configured to perform combined processing of at least one layer on the feature map using the image classification model, to obtain a combined-processed feature map outputted through the combined processing of the at least one layer, where in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract the intermediate feature according to the offset window, to obtain a feature map outputted at the layer.

The model processing module 1404 is configured to: determine an image classification feature based on the combined-processed feature map using the image classification model, and perform visually induced feeling/perception-based classification on the to-be-classified image according to the image classification feature.

In an embodiment, the apparatus further includes a content recommendation processing module, configured to: obtain a visually induced feeling/perception-based classification result of the to-be-classified image, and determine, according to the visually induced feeling/perception-based classification result, a visually induced feeling/perception attribute of content to which the to-be-classified image belongs; determine attribute information of the content, and update the visually induced feeling/perception attribute to the attribute information; and determine account information of an account, and recommend content to the account based on the attribute information of the content and the account information.

All or some of the modules in the foregoing image classification apparatus may be implemented by software, hardware, or a combination thereof. The foregoing modules may be built in or independent of a processor of a computer device in a form of hardware, or may be stored in a memory of the computer device in a form of software, so that the processor invokes and executes operations corresponding to the foregoing modules.

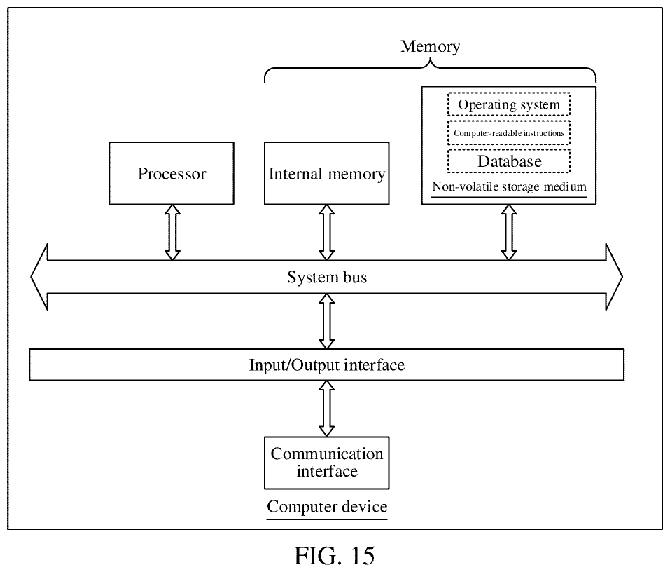

In an embodiment, a computer device is provided. The computer device may be a server or a terminal. An internal structural diagram thereof may be as shown in FIG. 15. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide calculation and control capabilities. The memory in the computer device includes a non-volatile storage medium and an internal memory. The non-volatile storage medium stores an operating system, computer-readable instructions, and a database. The internal memory provides an operating environment for the operating system and the computer-readable instructions in the non-volatile storage medium. The database of the computer device is configured to store image classification model data. The input/output interface of the computer device is configured to exchange information between the processor and an external device. The communication interface of the computer device is configured to connect to and communicate with an external terminal through a network. The computer-readable instructions are executed by the processor to implement an image classification method.

A person skilled in the art may understand that, the structure shown in FIG. 15 is merely a block diagram of a partial structure related to a solution in this disclosure, and does not constitute a limitation to the computer device to which the solution in this disclosure is applied. Specifically, the computer device may include more components or fewer components than those shown in the figure, or some components may be combined, or a different component deployment may be used.

In an embodiment, a computer device is further provided, including a memory and a processor. The memory stores computer-readable instructions, and when executing the computer-readable instructions, the processor executes operations in the method embodiments of this disclosure.

In an embodiment, a computer-readable storage medium is provided, having computer-readable instructions stored therein. When executed by a processor, the computer-readable instructions execute operations in the method embodiments of this disclosure.

In an embodiment, a computer program product is provided, including computer-readable instructions. When executed by a processor, the computer-readable instructions execute operations in the method embodiments of this disclosure.

User information (including but not limited to user equipment information, user personal information, and the like) and data (including but not limited to data for analysis, data for storage, data for display, and the like) involved in this disclosure are all information and data authorized by users or fully authorized by all parties, and collection, use, and processing of relevant data need to comply with relevant laws, regulations, and standards of relevant countries and regions.

A person of ordinary skill in the art may understand that some or all procedures in the method in the foregoing embodiments may be implemented by computer-readable instructions instructing related hardware, the computer-readable instructions may be stored in a non-volatile computer-readable storage medium, and when the computer-readable instructions are executed, the procedures in the foregoing method embodiments may be implemented. Any reference to a memory, a database, or another medium used in the various embodiments provided in this disclosure may include at least one of a non-volatile memory or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache, or the like. For illustration rather than limitation, the RAM may be in various forms, for example, may be a static random access memory (SRAM) or a dynamic random access memory (DRAM). The database involved in the embodiments provided in this disclosure may include at least one of a relational database and a non-relational database. The non-relational database may include a blockchain-based distributed database or the like, but is not limited thereto. The processor involved in the embodiments provided in this disclosure may be a general-purpose processor, a central processing unit, a graphics processor, a digital signal processor, a programmable logic device, a quantum computing-based data processing logic device, or the like, but is not limited thereto.

The technical features in the foregoing embodiments may be combined in different manners to form other embodiments. For concise description, not all possible combinations of the technical features in the embodiment are described. However, the combinations of the technical features are all to be considered as falling within the scope described in this specification provided that they do not conflict with each other.

The foregoing embodiments only describe several implementations of this disclosure, and are described in detail, but they are not to be construed as a limitation to the patent scope of this disclosure. A person of ordinary skill in the art may further make variations and improvements without departing from the ideas of this disclosure, which shall fall within the protection scope of this disclosure. Therefore, the protection scope of this disclosure shall be subject to the appended claims.

What is claimed is:

1. An image classification method, performed by a computer device, the method comprising:
obtaining a sample image, and mapping a plurality of image patches in the sample image using an image classification model, to obtain a feature map of the sample image, the feature map comprising feature patches, and each of the feature patches being obtained through feature mapping on each of the plurality of image patches;
performing combined processing of at least one layer on the feature map using the image classification model, to obtain a combined-processed feature map outputted through the combined processing of the at least one layer,
wherein in combined processing of each layer:
determining a self-attention window, a window size of the self-attention window matching a size of a feature patch in a target feature map inputted at the layer;
extracting an intermediate feature of a covered feature patch according to the self-attention window, the covered feature patch being a feature patch covered by the self-attention window in the target feature map;
determining an offset window that is offset from the self-attention window, and extracting an intermediate feature according to the offset window to obtain a feature map outputted at the layer;
determining an image classification feature based on the combined-processed feature map using the image classification model, and performing visually induced feeling-based classification on the sample image according to the image classification feature, to obtain a classification result of the visually induced feeling-based classification; and
updating a model parameter of the image classification model based on the classification result of the visually induced feeling-based classification, to obtain a target image classification model after training.

2. The method according to claim 1, further comprising:
determining a trained classification guide model, and performing visually induced feeling-based classification on the sample image using the trained classification guide model, to obtain a guide model classification result outputted by the trained classification guide model; and
the updating a model parameter of the image classification model based on the classification result of the visually induced feeling-based classification, to obtain a target image classification model after training comprising:
determining a training loss of the image classification model according to the classification result of the visually induced feeling-based classification and the guide model classification result; and
updating the model parameter of the image classification model based on the training loss, to obtain the target image classification model after training.

3. The method according to claim 2, wherein determining a training loss of the image classification model according to the classification result of the visually induced feeling-based classification and the guide model classification result comprises:
determining a visually induced feeling-based classification label of the sample image, and determining a classification loss of the image classification model according to the classification result of the visually induced feeling-based classification and the visually induced feeling-based classification label;
determining a distillation loss based on a difference between the classification result of the visually induced feeling-based classification and the guide model classification result; and
performing weighted fusion on the classification loss and the distillation loss, to obtain the training loss of the image classification model.

4. The method according to claim 2, further comprising:
performing image enhancement on the sample image to obtain an enhanced sample image; and
inputting the enhanced sample image into the image classification model for visually induced feeling-based classification, to obtain an enhanced sample classification result outputted by the image classification model; and
the updating a model parameter of the image classification model based on the classification result of the visually induced feeling-based classification, to obtain a target image classification model after training comprising:
determining a training loss of the image classification model according to the classification result of the visually induced feeling-based classification and the enhanced sample classification result; and
updating the model parameter of the image classification model based on the training loss, to obtain the target image classification model after training.

5. The method according to claim 4, wherein determining a training loss of the image classification model according to the classification result of the visually induced feeling-based classification and the enhanced sample classification result comprises:
determining a visually induced feeling-based classification label of the sample image, and determining a classification loss of the image classification model according to the classification result of the visually induced feeling-based classification and the visually induced feeling-based classification label;
determining a contrastive loss based on a difference between the classification result of the visually induced feeling-based classification and the enhanced sample classification result; and
performing weighted fusion on the classification loss and the contrastive loss, to obtain the training loss of the image classification model.

6. The method according to claim 5, further comprising:
determining an enhanced sample classification loss of the image classification model according to the enhanced sample classification result and the visually induced feeling-based classification label; and
the performing weighted fusion on the classification loss and the contrastive loss, to obtain the training loss of the image classification model comprising:
performing weighted fusion on the classification loss, the enhanced sample classification result, and the contrastive loss, to obtain the training loss of the image classification model.

7. The method according to claim 4, wherein performing image enhancement on the sample image to obtain the enhanced sample image comprises:
generating a mask image, an image size of the mask image matching an image size of the sample image; and
fusing the mask image and the sample image, to obtain the enhanced sample image.

8. The method according to claim 4, wherein updating a model parameter of the image classification model based on the classification result of the visually induced feeling-based classification, to obtain a target image classification model after training comprises:
determining a visually induced feeling-based classification label of the sample image, and determining a classification loss of the image classification model according to the classification result of the visually induced feeling-based classification and the visually induced feeling-based classification label;
determining a guide model classification result, and determining a distillation loss based on the classification result of the visually induced feeling-based classification and the guide model classification result, the guide model classification result being obtained by performing visually induced feeling-based classification on the sample image using the trained classification guide model;
determining an enhanced sample classification result, and determining a contrastive loss based on the classification result of the visually induced feeling-based classification and the enhanced sample classification result, the enhanced sample classification result being obtained through visually induced feeling-based classification on the enhanced sample image using the image classification model, and the enhanced sample image being obtained through image enhancement on the sample image;
performing weighted fusion on the classification loss, the distillation loss, and the contrastive loss, to obtain the training loss of the image classification model; and
updating the model parameter of the image classification model based on the training loss, to obtain the target image classification model after training.

9. The method according to claim 1, wherein the window size of the self-attention window and the size of a feature patch in the target feature map inputted at the layer satisfies a size matching relationship, and wherein extracting an intermediate feature of a covered feature patch according to the self-attention window comprises:
sequentially moving the self-attention window in the target feature map, and respectively extracting a moving window feature of each feature patch covered by the self-attention window during the movement;
performing residual fusion on the moving window feature to obtain a fused moving window feature; and
sequentially performing fully-connected mapping and residual fusion on the fused moving window feature, to obtain the intermediate feature.

10. The method according to claim 1, wherein extracting the intermediate feature according to the offset window to obtain a feature map outputted at the layer comprises:
sequentially moving the offset window in the intermediate feature, and respectively extracting an offset window feature of a feature patch covered by the offset window during the movement;
performing residual fusion on the offset window feature to obtain a fused offset window feature; and
sequentially performing fully-connected mapping and residual fusion on the fused offset window feature, to obtain the feature map outputted at the layer.

11. The method according to claim 1, wherein the at least one layer comprises a plurality of layers, and wherein performing combined processing of at least one layer on the feature map using the image classification model, to obtain a combined-processed feature map outputted through the combined processing of the at least one layer comprises:
determining a layer-specific self-attention window using the image classification model, a window size of the layer-specific self-attention window matching a size of a feature patch in the feature map inputted at a first layer, extracting a layer-specific intermediate feature of a covered layer-specific feature patch according to the layer-specific self-attention window, the covered layer-specific feature patch being a feature patch covered by the layer-specific self-attention window in the feature map, determining a layer-specific offset window that is offset from the layer-specific self-attention window, and extracting the layer-specific intermediate feature according to the layer-specific offset window that is offset, to obtain a feature map outputted at the first layer; and
performing, at each layer starting from the second layer of the plurality of layers, combined processing at the layer on a feature map outputted at a previous layer, to obtain a feature map outputted at the layer, until a combined-processed feature map of the plurality of layers is outputted through combined processing at a last layer.

12. The method according to claim 11, wherein performing, at each layer starting from the second layer of the plurality of layers, combined processing at the layer on a feature map outputted at a previous layer, to obtain a feature map outputted at the layer comprises:
merging, at each layer starting from the second layer of the plurality of layers, when the layer meets a feature patch merging condition, feature patches in the feature map outputted at the previous layer, to obtain a merged feature map; and
performing combined processing at the layer on the merged feature map, to obtain the feature map outputted at the layer.

13. The method according to claim 1, wherein mapping a plurality of image patches in the sample image using an image classification model, to obtain a feature map of the sample image comprises:
dividing the sample image using the image classification model to obtain the plurality of image patches;
mapping the plurality of image patches respectively using the image classification model, to obtain respective image patch mapping features of the plurality of image patches;
determining respective position features of the plurality of image patches using the image classification model according to respective distribution positions of the plurality of image patches in the sample image; and
respectively merging the respective image patch mapping features and the respective position features of the plurality of image patches using the image classification model, to obtain respective feature patches of the plurality of image patches.

14. An image classification method, performed by a computer device, the method comprising:
obtaining a to-be-classified image, and mapping a plurality of image patches in the to-be-classified image using an image classification model, to obtain a feature map of the to-be-classified image, the feature map comprising feature patches, and each of the feature patches being obtained through feature mapping on each of the plurality of image patches;
performing combined processing of at least one layer on the feature map using the image classification model, to obtain a combined-processed feature map outputted through the combined processing of the at least one layer, wherein in combined processing of each layer:
determining a self-attention window, a window size of the self-attention window matching a size of a feature patch in a target feature map inputted at the layer;
extracting an intermediate feature of a covered feature patch according to the self-attention window, the covered feature patch being a feature patch covered by the self-attention window in the target feature map;
determining an offset window that is offset from the self-attention window, and extracting an intermediate feature according to the offset window to obtain a feature map outputted at the layer; and
determining an image classification feature based on the combined-processed feature map using the image classification model, and performing visually induced feeling-based classification on the to-be-classified image according to the image classification feature.

15. The method according to claim 14 further comprising:
obtaining a visually induced feeling-based classification result of the to-be-classified image, and determining, according to the visually induced feeling-based classification result, a visually induced feeling attribute of content to which the to-be-classified image belongs;
determining attribute information of the content, and updating the visually induced feeling attribute to the attribute information; and
determining account information of an account, and recommending content to the account based on the attribute information of the content and the account information.

16. An image classification apparatus, comprising a memory for storing instructions and at least one processor for executing the instructions to:
obtain a sample image, and map a plurality of image patches in the sample image using an image classification model, to obtain a feature map of the sample image, the feature map comprising feature patches, and each of the feature patches being obtained through feature mapping on each of the plurality of image patches;
perform combined processing of at least one layer on the feature map using the image classification model, to obtain a combined-processed feature map outputted through the combined processing of the at least one layer, wherein in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract an intermediate feature according to the offset window, to obtain a feature map outputted at the layer;
determine an image classification feature based on the combined-processed feature map using the image classification model, and perform visually induced feeling-based classification on the sample image according to the image classification feature, to obtain a classification result of the visually induced feeling-based classification; and
update a model parameter of the image classification model based on the classification result of the visually induced feeling-based classification, to obtain a target image classification model after training.

17. An image classification apparatus, comprising a memory for storing instructions and at least one processor for executing the instructions to:
obtain a to-be-classified image, and map a plurality of image patches in the to-be-classified image using an image classification model, to obtain a feature map of the to-be-classified image, the feature map comprising feature patches, and each of the feature patches being obtained through feature mapping on each of the plurality of image patches; and
perform combined processing of at least one layer on the feature map using the image classification model, to obtain a combined-processed feature map outputted through the combined processing of the at least one layer, wherein in combined processing of each layer: determine a self-attention window, a window size of the self-attention window matching a size of a feature patch in a target feature map inputted at the layer, extract an intermediate feature of a covered feature patch according to the self-attention window, the covered feature patch being a feature patch covered by the self-attention window in the target feature map, determine an offset window that is offset from the self-attention window, and extract an intermediate feature according to the offset window, to obtain a feature map outputted at the layer;
determine an image classification feature based on the combined-processed feature map using the image classification model, and perform visually induced feeling-based classification on the to-be-classified image according to the image classification feature.

18. A computer device, comprising a memory and a processor, the memory storing computer-readable instructions, and when executing the computer-readable instructions, the processor is configured to implement operations of the method according to claim 1.

19. A computer-readable storage medium, having computer-readable instructions stored therein, and when being executed by a processor, the computer-readable instructions are configured implement operations of the method according to claim 1.

20. A computer program product, having computer-readable instructions stored therein, and the instructions, when being executed by a processor, are configured to implement operations of the method according to claim 1.
